(19) United States
(12) Patent Application Publication
(10) Pub. No.: US 2021/0407046 A1
(43) Pub. Date: Dec. 30, 2021

(54) INFORMATION PROCESSING DEVICE, INFORMATION PROCESSING SYSTEM, AND INFORMATION PROCESSING METHOD

(71) Applicant: OCTEC Inc., Tokyo (JP)

(72) Inventors: Pierre KOPFF, Tokyo (JP); Hiroyuki TOKUSHIGE, Tokyo (JP); Raphael LABAYRADE, Vaulx-en-Velin (FR)

(21) Appl. No.: 16/643,421

(22) PCT Filed: Aug. 30, 2018
(86) PCT No.: PCT/JP2018/032246

§ 371 Date: Oct. 22, 2020

(30) Foreign Application Priority Data
Aug. 30, 2017 (JP) 2017-166119

(51) Int. Cl. G06T 5/00; G06T 5/50

(52) U.S. Cl. CPC G06T 5/001; G06T 2207/30252; G06T 5/50

(57) ABSTRACT

The invention relates to an information processing system (20), etc. capable of performing a display according to an absolute value of luminance.

The information processing system (20) comprises a first luminance correction information acquisition unit (61) which measures from a predetermined spatial position, the display device (30) displaying an image on the basis of an input signal, to obtain the luminance correction means of the input signal so that the finally displayed image corresponds to the luminance information contained in said input signal; a second acquisition unit (62) of the image data to be displayed on said display unit (30), a luminance correction unit (63) which corrects the image data acquired by the second acquisition unit (62) on the basis of the correction information acquired by the first luminance correction unit (61), an output transmission unit (64) which communicates the image data corrected by the correction unit (63) to the display unit (30).

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention relates to a data processing device, a data processing system and a data processing method.

### 2. Description of Related Art Including Information Disclosed Under 37 CFR 1.97 and 37 CFR 1.98

The so-called uniformity correction, which corrects the luminance displayed on the screen so that it is as uniform as possible over the entire screen surface—the so-called display device with uniformity correction—is provided in devices used in the medical and printing industries, for example. Uniformity correction is used to correct the red, green and blue (RGB) signals of each pixel that make up an input image. The displayed signals are obtained by multiplying the input data with predetermined uniformity correction factors.

An image processing device that shifts the positions of pixels integrating R, G and B signals from several units to several tens of units when multiplying the input data by the uniformity correction factors, thereby preventing the generation of a grid-like luminance distribution, is proposed (reference patent 1).

### PRESENTATION OF THE PRIOR ART

### Patent Reference

Publication of patent reference no.1: 2016-46751

### BRIEF SUMMARY OF THE INVENTION

### Purpose of the Present Invention

The image processing device described in reference patent 1 adjusts the luminance of the screen relatively. Under these conditions, the display cannot be based on the absolute value of the luminance.

A principal but not limiting objective of the invention is to provide an information processing device or the like that can perform an image display based on an absolute value of luminance.

### Means to Achieve the Objective

The information processing device is capable of measuring from a predetermined measuring position, the brightness of the display unit that displays the image in relation to the input signal. The first acquisition unit acquires the luminance correction information that relates to the luminance information contained in the input signal. The second acquisition unit acquires the image data to be displayed by the display unit. A luminance correction unit corrects the data acquired by the second acquisition unit on the basis of the luminance correction information acquired by the first acquisition unit. An output transmission unit transmits the image data corrected by the correction unit to the display unit.

### Advantage of the Invention

The invention provides an information processing or similar device capable of performing an image display based on an absolute value of luminance.

### BRIEF DESCRIPTION OF THE SEVERAL VIEWS OF THE DRAWINGS

FIG. 1 is a schematic view of an illustration of an overview of an information processing system with application of the invention.

FIG. 2A is a schematic view of an illustration of an overview of a method for measuring luminance distribution.

FIG. 2B is a schematic view of an illustration of a measurement of the luminance distribution.

FIG. 3 is a schematic view of an illustration of the configuration of an information processing system in the preparation phase.

FIG. 4 is a graph illustrating the relationship between the input level values of a projector and luminance.

FIG. 5 is a table for recording a luminance measurement database.

FIG. 6 is a table of registration of a luminance correction database.

FIG. 7 is a flowchart illustrating the execution of a program for the preparation phase.

FIG. 8 is a flowchart showing the flow of a subroutine for calculating luminance correction values.

FIG. 9 is a flowchart showing the flowchart of a program in the operational use phase.

FIG. 10 is a flowchart showing the flow of a program in the operational use phase according to configuration 2.

FIG. 11 is a flow chart for the composition of an information processing system in the acquisition phase for shape correction according to configuration 3.

FIG. 12 is a flow chart for the layout of an information processing system in the step of acquisition of a luminance distribution according to configuration 3.

FIG. 13 is a flow chart for a layout of projectors and a screen.

FIG. 14A is a schematic view of an illustration of projectors and a screen seen from above.

FIG. 14B is a schematic view of an illustration of projectors and a screen seen from the right side.

FIG. 15A is a schematic view of an illustration that shows projectors in the projection phase.

FIG. 15B is a schematic view of an illustration that shows projectors in the projection phase.

FIG. 16A is a schematic view of an illustration that shows projectors in the projection phase.

FIG. 16B is a schematic view of an illustration that shows projectors in projection phase.

FIG. 17 is a schematic view of an illustration of an example of the result of the luminance measurement according to configuration 3.

FIG. 18 is a flow chart showing the flow of a program in the preparation phase according to configuration 3.

FIG. 19 is a flowchart illustrating the flow of an acquisition sub-program for shape correction.

FIG. 20 is a flowchart illustrating the flow of a sub-program for the acquisition of the luminance distribution.

FIG. 21 is a flowchart illustrating the flow of a program in operational use according to configuration 3.

FIG. 22A is a schematic view of an illustration that shows projectors, auxiliary projectors and a screen seen from above.

FIG. 22B is a schematic view of an illustration that shows projectors, auxiliary projectors and a screen viewed from the rear of the projectors.

FIG. 23 is a schematic view of an illustration that shows projectors in projection phase according to configuration 4.

FIG. 24 is a schematic view of an illustration that shows the arrangement of projectors and a screen according to configuration 5.

FIG. 25 is a schematic view of an illustration that shows the layout of an information processing system in operational use according to configuration 6.

FIG. 26 is a block diagram illustrating the operation of an information processing device according to configuration 7.

FIG. 27 is a schematic view of an illustration that represents the composition of an information processing system according to configuration 8.

FIG. 28A is a schematic view of an illustration that represents the conversion between the coordinates of an image projected by a projector and the coordinates of the projection area in the operational phase.

FIG. 28B is a schematic view of an illustration represents the conversion between the coordinates of an image projected by a projector and the coordinates of the projection area in operational phase.

FIG. 29A is a schematic view of an illustration represents a conversion between the coordinates of the projection area in operational phase and the original image data.

FIG. 29B is a schematic view of an illustration represents a conversion between the coordinates of the projection area in operational phase and the original image data.

FIG. 30 is a schematic view of an illustration represents a table for storing a second conversion database.

FIG. 31 is a schematic view of an illustration represents a table for storing a second conversion database.

FIG. 32 is a flowchart showing the program flow according to configuration 9.

FIG. 33A is a schematic view of an illustration of a projection state on a screen of four projectors, from the first to the fourth projector.

FIG. 33B is a schematic view of an illustration that shows a projection area in operational phase superimposed on the projection state shown in FIG. 33A.

FIG. 34A is a schematic view of an illustration that represents a second variant of shape correction according to configuration 9.

FIG. 34B is a schematic view of an illustration that represents a second variant of shape correction according to configuration 9.

### DETAILED DESCRIPTION OF THE INVENTION

Configuration 1

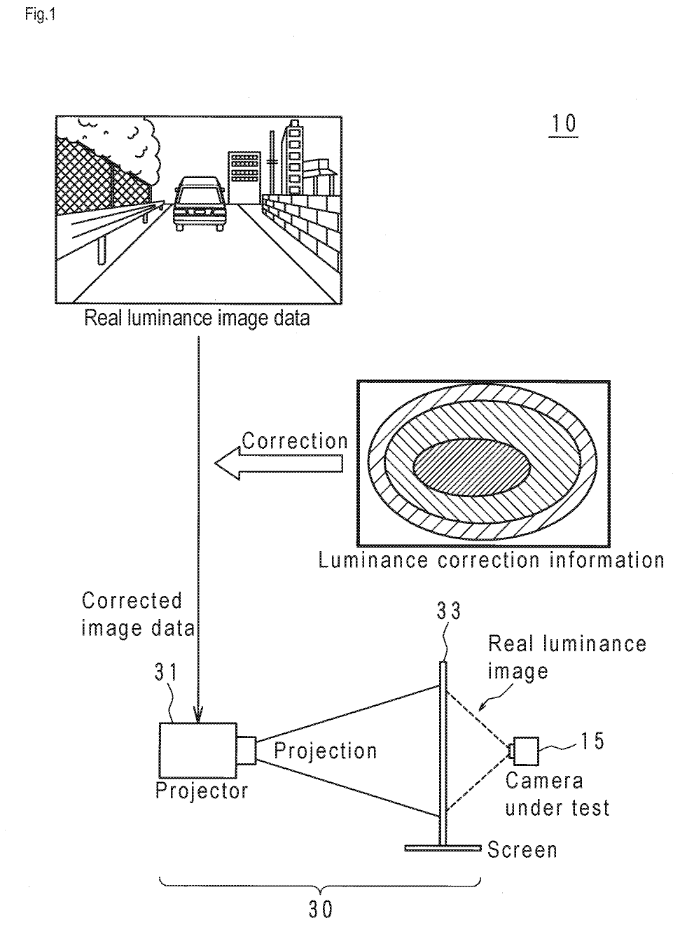

FIG. 1 is an illustration that provides an overview of the information processing system 10. The information processing system 10 is shown here in the case of a use in order to test and evaluate a camera 15, such as, for example, an on-board camera in a motor vehicle.

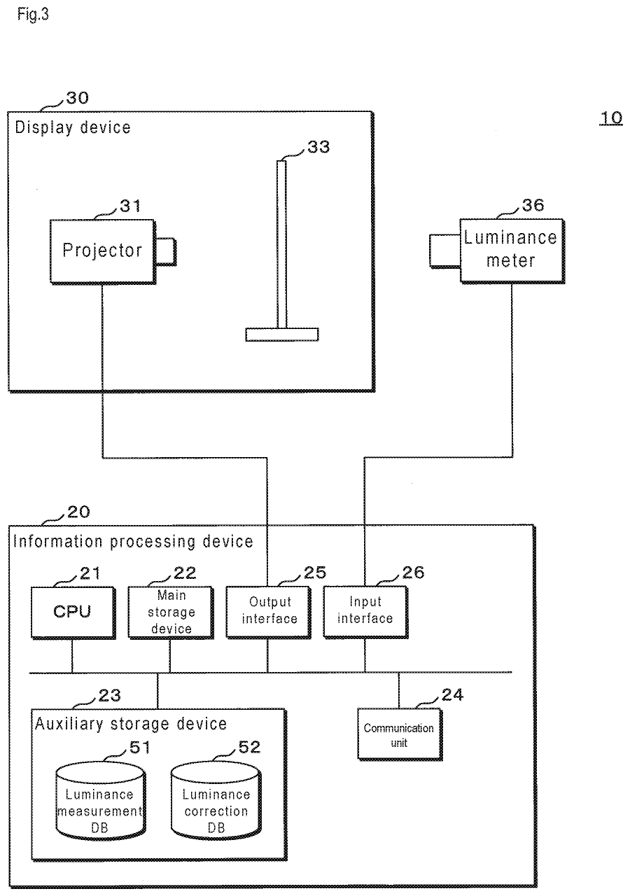

The information processing system 10 consists of an information processing device 20 (see FIG. 3) connected to a display device 30. The display device 30 consists of projectors 31 and a screen 33 for rear projection. The camera to be tested 15 is positioned in front of the projectors 31 and beyond the screen 33.

Real luminance image data, including luminance information corresponding to real luminance, is input into the information processing device.20 Here, “real luminance” is related to an inherent spectral sensitivity curve, such as a target luminance and a trichromatic component, based on spectral radiance. It is a physical quantity or spectral radiance whose value is uniquely determined. Displaying in “real luminance” means reproducing the absolute physical quantity described above and displaying it as such.

The data of an image and real luminance are, for example, those of a real image taken by a two-dimensional color luminance meter at high resolution 36. To obtain the data of images in real luminance, a calibration in luminance must be carried out beforehand to allow the shooting in real luminance. It can also be a real image taken by a digital camera. The real luminance image data can still be a synthetic image created by a simulation tool based on physical theory. Finally, the real luminance data can be a spectral image taken by a hyperspectral camera or any other such device.

The actual luminance data of the image can, for example, be used to convert each pixel of the image to be displayed using the X, Y and Z trichromatic components of the CIE color system (CIE: International Commission on Illumination). Each pixel of the image to be displayed can alternatively take a value from the CIELAB color space (CIE L*a*b*) or a value from the CIERGB color space (CIE Red Green, Blue) or finally a specific value from the CIELMS color space (CIE Long Medium Short), etc. It integrates a spectral sensitivity curve and is represented by a physical quantity whose value is specifically determined from the spectral radiance. The physical quantity is not limited to three dimensions; it can be a physical quantity in one, two or more four dimensions. Real luminance image data can be the image data that includes the spectral radiance of each pixel.

Real luminance image data can also be a set of image or video data in a common format such as JPEG (Joint Photographic Experts Group) or PNG (Portable Network Graphics) associated with reference information or similar that maps RGB gradation values to a luminance level appropriate to that data.

Real luminance image data can also be image data or video data in a common format, such as JPEG or PNG, combined with data that maps recorded RGB gradation values to luminance levels in relation to the gamma value and color sensitivity information of the shooting equipment.

The real luminance image data is luminance-corrected according to the luminance correction information described below. The image data after luminance correction is input to the projectors 31. Projectors 31 project the image on screen 33 based on the input image data. In the case of this configuration, projectors 31 invert the left and right sides of the input image, such a projection mode is called back-projection.

The image is projected on screen 33 in a rear-projection mode. Here is an example of a case in which the image is viewed from a position approximately opposite the projector 31. In general, the rear-projection image is based on the light distribution characteristics of projector 31 and the orientation of screen 33, with high luminance in the central part and lower luminance at the periphery. For example, when the observation position is moved to the right, the area of high luminance seems to move to the right.

The luminance correction information corrects the luminance distribution and the absolute luminance value, which vary depending on the observation position. In the following explanations, the processing step is referred to as the “preparatory phase” until the luminance correction information is created. In the following explanations, the position from which the luminance is measured in order to create the luminance correction information is called the measurement position.

Once the preparation phase has been completed, the information processing system 10 of this configuration enters the operational use phase. In the operational use phase, the real luminance image data, corrected with the luminance correction information corresponding to a measurement position, is input to projectors 31 and projected onto screen 33. From the measurement position, it is possible to display a real luminance image that is faithful to the real luminance image data. By placing the test camera 15 in the measurement position, the test camera 15 allows real luminance images to be taken.

The testing of a camera 15 using a system as described above allows, for example, the evaluation of the effects of glare in the lenses and ghost images related to the headlights of a vehicle coming in the opposite direction. or related to the variation of luminosity before and after a tunnel, on the creation of images by the said camera. As it is easy to evaluate several camera models 15 under identical conditions, useful information can thus be obtained, for example, for the selection of onboard camera models.

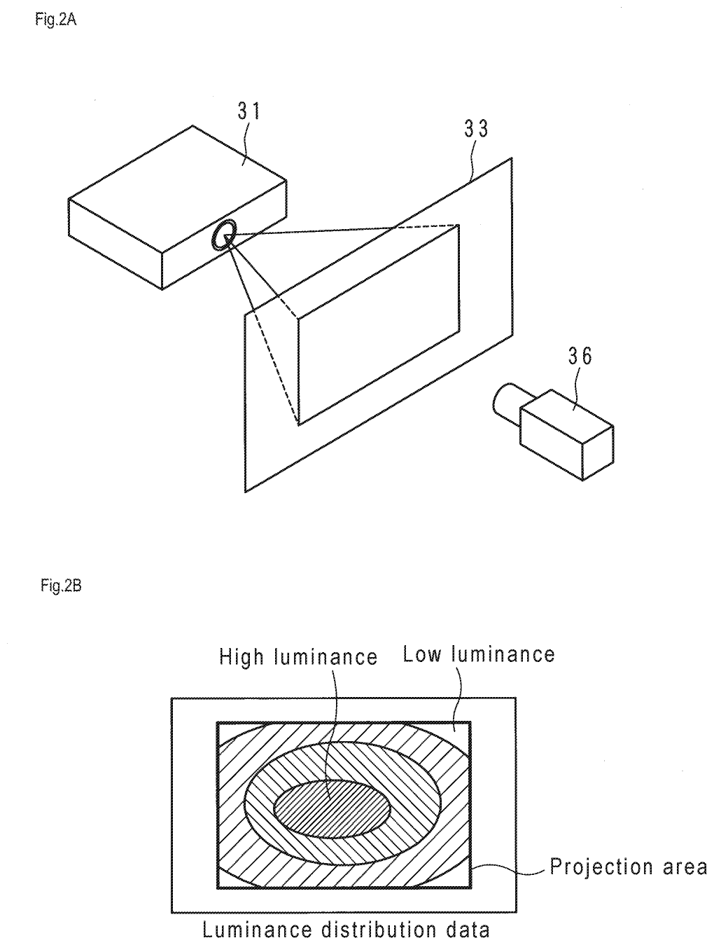

FIG. 2 shows an overview of the measurement of luminance distribution. As shown in FIG. 2A, a uniform image is projected onto screen 33 by projectors 31, which are gray, white or black in color. In the following explanations, the term “gray” is used for all shades from white to black. The luminance of the projected image is measured for each point using a luminance meter 36 placed at the measurement position.

After a luminance measurement is completed, the projected gray level of the image projected by projectors 31 on screen 33 is changed and the luminance is measured again. Based on the above, the luminance at each of the image points is measured in correspondence to several different gray levels projected by projectors 31.

In the present configuration, a high-resolution two-dimensional color luminance meter is used as luminance meter 36. A two-dimensional luminance meter can also be used as luminance meter 36. The luminance in each point of the image can be measured by a luminance meter capable of measuring the luminance of only one point by using a mechanical scanning of the screen 33.

FIG. 2B shows an example of luminance measurement results. The luminance at the center of the projection area is high and decreases towards the edges. The state of the luminance distribution is affected by the measurement position, the individual differences between the projectors 31, the position of the screen 33 in relation to the projectors 31. The state of the luminance distribution also changes with the degradation of the lamps, the light sources of projectors 31, over time.

FIG. 3 is an illustration of the composition of the information processing system 10 in the preparation phase. The information processing system 10 under preparation consists of an information processing device 20, a display device 30 and a luminance meter 36.

The information processing device 20 consists of a central processing unit (CPU) 21, a main memory 22, an auxiliary memory 23, a communication unit 24, an output interface 25, an input interface 26 and a computer bus. The data processing device 20 in this configuration is a data processing device such as a conventional personal computer or tablet.

The CPU 21, in the case of the present configuration, is a management unit for the calculation operations to run the program. The CPU 21 can use one or more processing units, or a multi-core unit. Instead of several CPUs or multi-core CPUs, or in addition to one or more CPUs or multi-core CPUs, FPGAs (User Programmable Logic Gates), CPLD (Programmable Complex Logic Device), ASICs (Application Specific Integrated Circuits) or GPUs (Graphics Processing Units) can also be used. The CPU 21 can be connected via a computer bus to the hardware parts making up the information processing device 20.

Main memory 22 is a storage device such as SRAM(static random access memory), DRAM (dynamic random access memory) or flash memory. Main memory 22 contains the information necessary during the processing performed by the information processing device 20 and temporarily stores the program executed by said information processing device 20.

Auxiliary storage device 23 can be a memory such as SRAM, flash memory, hard disk, or magnetic tape. Auxiliary storage device 23 may contain the program to be executed by CPU 21, a luminance measurement database 51 or the basis of luminance correction variables 52, as well as various information necessary for program execution.

The basis of the luminance measurement data 51 and the basis of the luminance correction variables 52 can be stored in a different storage device which is connected to the data processing device 20 via a network. The data can be who was manufactured. The details of each database or variable will be described below. The communication unit 24 is an interface for communication with a network.

The output interface 25 is an interface for outputting the image data to be displayed by the display device 30. The input interface 26 is an interface allowing the acquisition of the results of the luminance measurements by the luminance meter 36. Input interface 26 can also be an interface for reading data measured in advance by the luminance meter 36 using a portable storage medium such as an SD (secure digital) memory card.

The display device 30 is equipped with a screen 33 and projectors 31. Screen 33 is for rear projection. Screen 33 is only an example of a display unit that can be used in this configuration.

The display device 30 can include a front projector 31 with a screen 33 suitable for front projection. The display device 30 can also be a liquid crystal or electroluminescence (OLED) display panel, or any other type of display panel.

In the operational use phase, instead of the luminance meter 36, a camera 15 under test can be placed as shown in FIG. 1, this is only an example. The camera 15 to be tested does not need to be connected to the input interface 26.

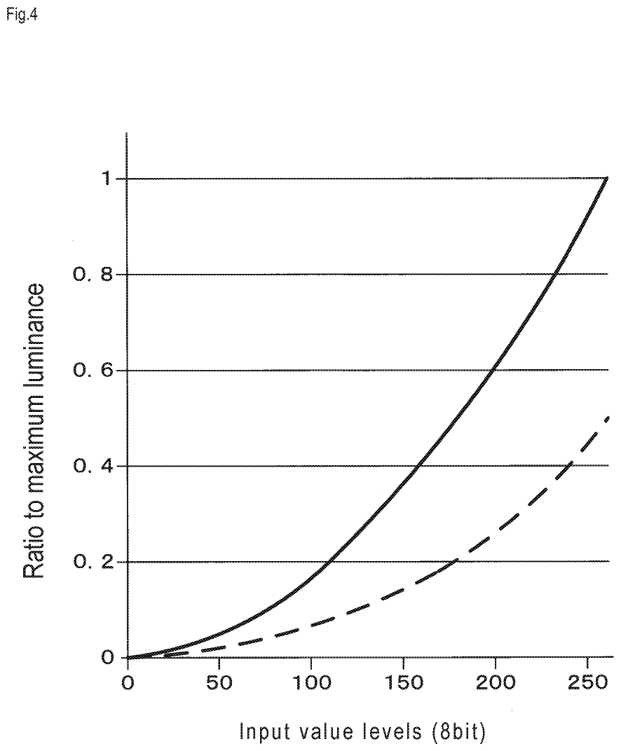

FIG. 4 is a graph showing the relationship between the level input value of one of the projectors 31 and the luminance. The horizontal axis in FIG. 4 corresponds to the tonal value of an image whose entire surface is gray and transmitted to the input of projectors 31 via the output interface 25. In the present confirmation, the signal at the input of projectors 31 is encoded in 8 bits, with a value from 0 to 255, i.e. 256 shades of gray that can be transmitted in this way. When the input value is 0, it means a black color, and when the input value is 255, it means a white color. The input signal of projectors 31 can be encoded in a number of bits greater than 8 bits.

The vertical axis in FIG. 4 is the ratio between the point luminance measured by the luminance meter 36 and the maximum luminance, i.e. the maximum luminance value in the display area. It expresses a normalization of the actual luminance measurements by the maximum luminance. The solid line shows the measurement results for the center of screen 33 and the dotted line shows an example of measurement results for the edge of screen 33. The higher the input level value, the higher the actual luminance measurement. For any input gray value, the luminance value measured at the edges is lower than that measured at the center.

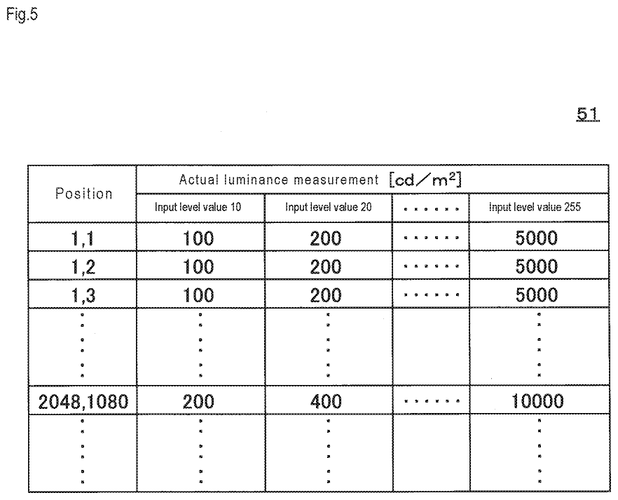

FIG. 5 shows the recording table of the actual luminance measurement in the form of a database 51. The database of luminance measurements 51 relates a point position on screen 33 to the actual luminance value measured by the luminance meter 36. The database of luminance measurements 51 has a series of position fields and fields of luminance measurement values. It has any number of fields corresponding to an input level, such as level 10 field, level 20 field and level 255 field.

In the position field, the position on screen 33 is recorded by the X and Y coordinates. In the present configuration, the X and Y coordinates result from the positions of the measurement pixels by the two-dimensional color luminance meter 36. The level 10 field gathers the actual luminance measurement data of each position on the screen corresponding to the input level of 10 transmitted by the output interface 25 to the projectors 31. In this case, the entire screen surface is displayed by the projectors 31 at this input level 10 as a dark gray screen. The unit of measurement for luminance is the candela per square meter.

Similarly, in the input level 20 field are the luminance values measured at each of the points on the screen corresponding to input level 20 transmitted by output interface 25 to the projectors 31. The level 255 field records the actual luminance values on each of the points of the screen corresponding to level 255 input to the projectors via output interface 25.

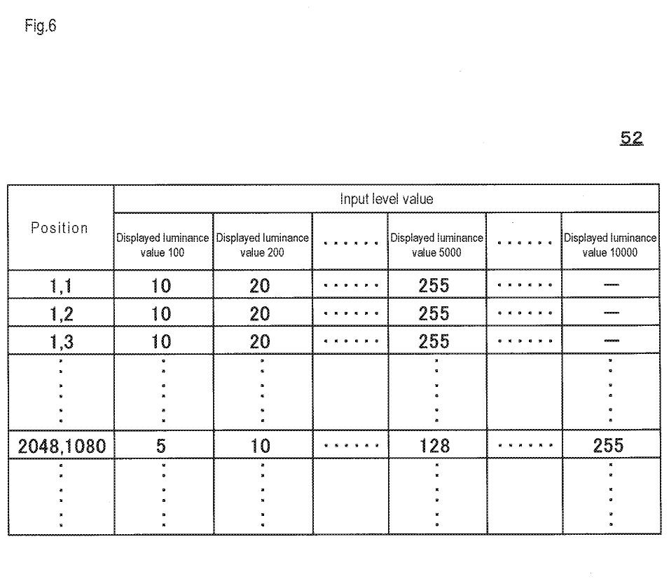

FIG. 6 shows a recording layout of the luminance correction variable base 52. The basis of the luminance correction variables 52 is a basis that records the relationship between the position on the screen and the gray scale value that is input from the output interface 25 to the projectors 31 in order to be able to obtain a predetermined display luminance value. An example of luminance correction information in the case of this configuration is the information stored in the luminance correction variable base 52.

The basis of the luminance correction variables 52 has a position field and input level value fields. The input level value fields can be in any number depending on the display level in luminance displayed, e.g. luminance 100, luminance 200, luminance 5000 or luminance 10000.

In the position field, any position on screen 33 is recorded by its X and Y coordinates. In the displayed luminance field of level 100, the value of the input level to the projector from output interface 25 is recorded when the displayed luminance value is 100 candela/square meter, as measured by a luminance meter placed at the measurement location.

Similarly, in the field of the displayed luminance value 200, the recorded values correspond to the input level via the output interface 25 to the projector when the displayed luminance value is 200 candela/square meter, measured by a luminance meter 36 placed at the measurement location. In the displayed luminance field 5000, the input level values to the projectors 31 via the output interface are recorded for the displayed luminance value of 5000 candelas/square meter, measured by a luminance meter 36 placed at the measuring location.

FIGS. 5 and 6 are used to illustrate a specific example. As shown in FIG. 5, when the input level value is 10 at position (1, 1), the actual measured luminance value is 100 candela/square meter. Therefore, as shown in FIG. 6, at position (1, 1), to obtain a luminance value on the screen of 100 candela/square meter, the required input level value is 10.

In FIG. 6, a “-” sign indicates that the addressed luminance is not obtained. For example, at position (1, 1), even if the value of the input level is increased, the value of 10000 luminance on the display in candela/square meter is not available.

If a luminance value corresponding to the displayed luminance value field in FIG. 6 is not recorded as an actual luminance measurement by the database 51 shown in FIG. 5, the input level value is obtained by an interpolation process according to any method, such as linear interpolation, and is recorded in the display luminance value field.

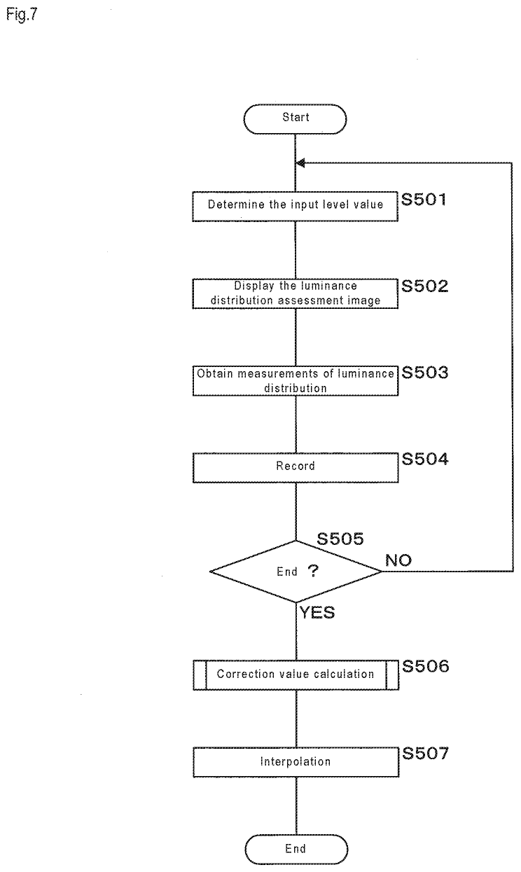

FIG. 7 is a flow chart illustrating the program flow in the preparation phase. The program shown in FIG. 7 is executed once the screen 33 and the projectors 31 are set up, the optical focusing is done, and the luminance meter 36 is placed in the measuring position.

The CPU 21 determines the value of the input levels (step S501). The value of the input levels can be defined as any value, for example, with a step of ten levels. The evaluation image of the brightness distribution is displayed by display device 30 (step S502). Specifically, the CPU 21 transmits to the projectors 31, via the output interface 25, the data of a brightness distribution evaluation image whose entire surface corresponds to the levels determined in step S501. The projector projects the image onto the screen according to the acquired image data. The evaluation image of the brightness distribution is then displayed on the screen. The evaluation image of the brightness distribution can be, for example, an image in which the different levels are arranged in a checkerboard pattern.

The CPU 21 obtains measurements of the luminance distribution via the luminance meter 36 and the input interface 26 (step S503). The CPU 21 stores (step S504) the measured values in the field corresponding to the value of the input levels determined in step S501 as a record corresponding to each coordinate position of the luminance measurement database 51.

The central unit 21 determines whether or not the measurement of the predetermined input level value has been carried out (step S505). If it is determined that it has not been completed (NO in step S505), CPU 21 returns to step S501. If it is determined that it is complete (YES in step S505), CPU 21 proceeds to calculate the correction value and starts the corresponding subroutine (step S506). The subroutine for the calculation of the correction value creates a base of luminance correction variables 52 based on the actual luminance measurements 51. The processing flow of the subroutine for the calculation of the correction value is described below.

CPU 21 interpolates the basis of the luminance correction variables 52 to match the resolution of the input data to be introduced into projectors 31 (step S507). Specifically, CPU 21 adds records to the basis of luminance correction variables 52 so that the number of display pixels by the projectors corresponds to the number of records in the luminance correction basis 52. CPU 21 records the input level values for each field of the added records based on an arbitrary interpolation technique. In addition, CPU 21 corrects the data in the position field to match the positions of the projector pixels. CPU 21 then terminates the process.

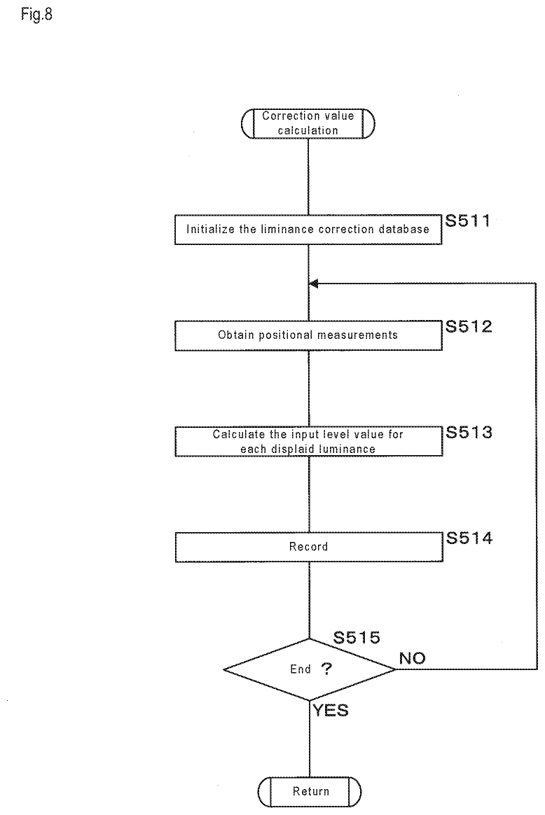

FIG. 8 is a flowchart illustrating the flow of the subprogram for the calculation of the correction value. CPU 21 initializes base 52 of the luminance correction variables (step S511). Specifically, CPU 21 deletes the existing records from luminance correction base 52 and creates the same number of records as base 51 of the actual luminance measurements. CPU 21 stores the same data in the position field of each record as in the position field of base 51 of the actual luminance measurements.

The CPU 21 obtains a measurement result of base 51 of the luminance measurements showing the relationship between the input level value and the luminance value corresponding to a record of base 51, i.e. a position on the screen (step S512).

CPU 21 calculates the input level values corresponding to the luminance values of each display luminance value field in Luminance Correction Base 52 (step S513). The CPU calculates the input level values for a given display luminance value, for example, by linear interpolation of the data acquired in step S512. The CPU 21 calculates the input level values for a given display luminance value based on the data acquired in step S512. For example, a function indicating the relationship between the input level value and the display luminance value can be calculated by the method of least squares or a similar method, and the input level value for a given display luminance value can be calculated based on the calculated function.

CPU 21 stores the input level values for each display luminance value calculated in step S513 in the storage of base 52 of the luminance correction variables corresponding to the position obtained in step S512 (step S514).

The CPU 21 determines whether or not it has completed processing all records of the actual luminance measurement base 51 (step S515). If it is determined that processing is not completed (NO in step S515), CPU 21 returns to step S512. If it is determined that processing is complete (YES in step S515), CPU 21 terminates the process.

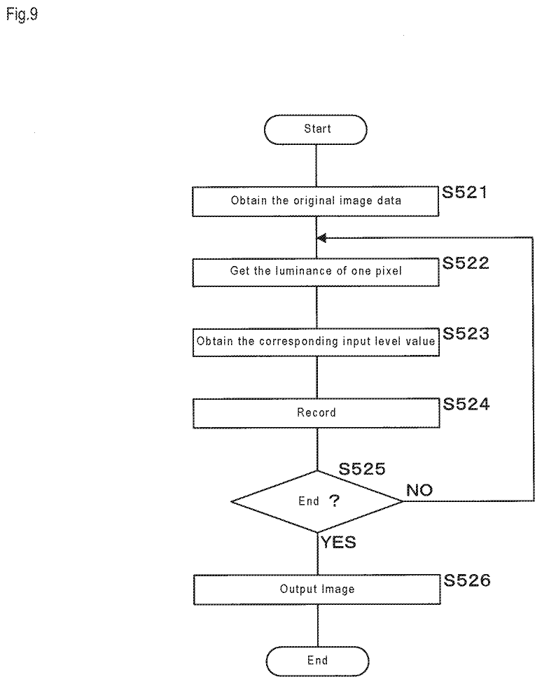

FIG. 9 is a flowchart illustrating the processing flow of the program during the operational use phase. CPU 21 obtains the original image data from an auxiliary storage device 23 or another server or similar connected via a network (step S521). CPU 21 can obtain the original image data via an interface such as HDMI or similar. The original image data can be generated by simulation software. CPU 21 can store the original image data acquired externally in an auxiliary storage device 23 and then acquire it again. The original image data are the real luminance image data, including the real luminance information. By step S521, the CPU 21 performs the function of the second acquisition unit in the case of this configuration.

The CPU 21 acquires the luminance value of a pixel in the image acquired in step S521 (step S522). The CPU 21 extracts the record corresponding to the position of the pixel acquired in step S522 from the luminance correction database 52. The central processing unit 21 then acquires the value of the input level of the field corresponding to the luminance value acquired in step S522 (step S523). By step S523, the central processing unit 21 carries out the function assigned to the first acquisition unit of the present configuration.

If the luminance correction in DB 52 does not have a field corresponding to the luminance value obtained in step S522, CPU 21 calculates the value of the input level by interpolation.

CPU 21 records the input level values obtained in step S523 in relation to the pixel positions obtained in step S522 (step S524). In step S524, CPU 21 performs the function assigned to the luminance correction unit of this configuration. CPU 21 determines whether or not the processing of all pixels of the original image data has been completed (step S525). If it is determined that processing is not complete (NO in step S525), CPU 21 returns to step S522.

When processing is considered complete (YES in step S525), the CPU 21 transmits the image data to projector 31 via output interface 25 based on the input level values of each pixel recorded in step S524 (step S526). With step S526, CPU 21 performs the function assigned to the output unit in the present configuration. Projector 31 projects the image on screen 33 based on the input image data. Afterwards, the central processing unit ends the processing process.

According to the procedure described above, screen 33 displays an image in real luminance when viewed from the measurement position.

In application of the present configuration, an information processing device 20 or similar can be realized, capable of a display according to an absolute value of luminance.

As an application example, by placing a test camera 15 at the measurement position and aiming the image at the screen 33, an evaluation of the test camera 15 can be performed using real luminance images.

Using the information processing system 10 as described in its present configuration, it is possible to evaluate, on the images taken by the camera to be tested 15, the effects of lens glare and ghost images caused, for example, by the headlights of oncoming motor vehicles, or changes in brightness at the entrance and exit of tunnels.

The image displayed in real luminance can be dynamic, for example a video. By switching the image to be projected from projector 31 to screen 33 at a predetermined frame rate, a video can be displayed on screen 33 in real luminance. This can make it possible, for example, to check the operation of the autonomous driving system on the basis of images captured by an on-board camera. It is also possible to carry out driving simulations and other applications using the images displayed in real luminance.

Configuration 2

The present configuration concerns an information processing device 20 that creates luminance correction information for a plurality of measurement positions and displays corrected images according to the measurement position closest to the position where the camera 15 to be tested or its equivalent will have been installed. The description of the common parts with configuration 1 will be omitted.

In this configuration, the process corresponding to the preparation step as described in FIG. 7 is carried out for a plurality of measurement positions. The basis of the luminance correction data 52 corresponding to each measurement position is stored in the auxiliary storage unit 23.

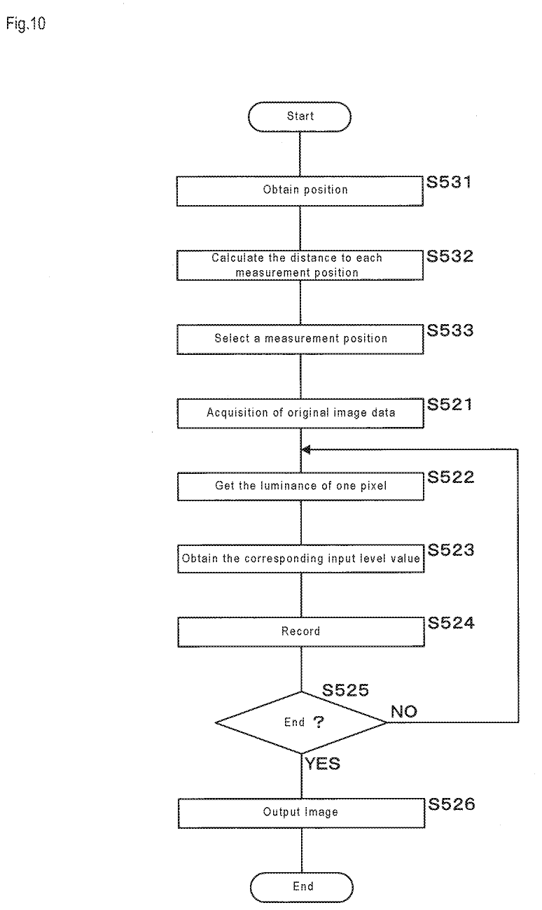

FIG. 10 is a flowchart illustrating the processing flow of the program in the use phase of Configuration 2. The CPU 21 obtains the position of camera 15 or other equipment to be tested, for example, from a position acquisition unit such as a position sensor or equivalent (step S531).

CPU 21 calculates the distance (step S532) between the position acquired in step S531 and each of the multiple measurement positions for which luminance correction information was previously created. A measurement position for luminance correction is selected by CPU 21 (step S533). Further processing is performed using the luminance correction database 52 corresponding to the selected measurement position.

In step S533, the measurement position closest to the position acquired in step S531 can be selected. In step S533, several measurement positions close to the position acquired in step S531 can also be selected and the measurement value at the position acquired in step S531 can be estimated by interpolating the data.

CPU 21 obtains the original image data from Auxiliary Storage Unit 23 or another server or similar equipment connected via a network (step S521). Since the further processing is the same as the processing performed by the configuration 1 program described in FIG. 9, the description will be omitted.

According to the present configuration, the information processing system 10 can be realized by selecting the closest measurement position from a plurality of measurement positions in order to perform the luminance correction. As an application example, the data processing system 10 is able to display a real luminance image even when the position of the test camera 15 is changed.

In step S502 of the program described using FIG. 7, a luminance image can be displayed separately for each of the three primary colors, R (Red), G (Green), and B (Blue). A database of the real measurements of luminance 51 as well as a database of the corrections of luminance 52 can be created for each of these three primary colors. It is possible to realize a system of information processing 10 which prevents the appearance of a bias in color caused by chromatic aberration, among other causes of aberration.

Configuration 3

The present configuration concerns an information processing system 10 that superimposes an image projected on a screen 33 from a plurality of projectors 31. The descriptions of the common parts with configuration 1 will be omitted.

In this configuration, the preparation step consists of two stages: a deformation acquisition step and a luminance distribution acquisition step. FIG. 11 is an illustration of the configuration of the information processing system 10 at the deformation acquisition stage for the present configuration 3.

The information processing system 10 in the deformation acquisition phase is equipped with an information processing device 20, a display device 30 and a luminance meter 36.

The information processing device 20 is equipped with a central processing unit 21, a main storage memory 22, an auxiliary storage memory device 23, a communication unit 24, an output interface 25, an input interface 26, a control display 27 and a bus. The control screen 27 is a liquid crystal display device or similar, for example, provided in the information processing device 20. The Information Processing Device 20 in this configuration may be a personal computer or general purpose tablet or other equivalent information processing device.

The display device 30 comprises a screen 33 and a plurality of projectors 31, such as a first projector 311, a second projector 312, and so on. In the following description, the individual projectors 31 will be referred to generically as projector 31 when they do not need to be distinguished. The arrangement of projectors 31 will be described below.

A camera 37 is connected to the input interface 26. Camera 37 is placed in a position opposite to projector 31, in front of screen 33 and facing projector 31. Camera 37 can be placed on the same side as the first projector 311 or similar projector but in such a way that it does not block the projection path of projector 31. Camera 37 is a high-resolution digital camera.

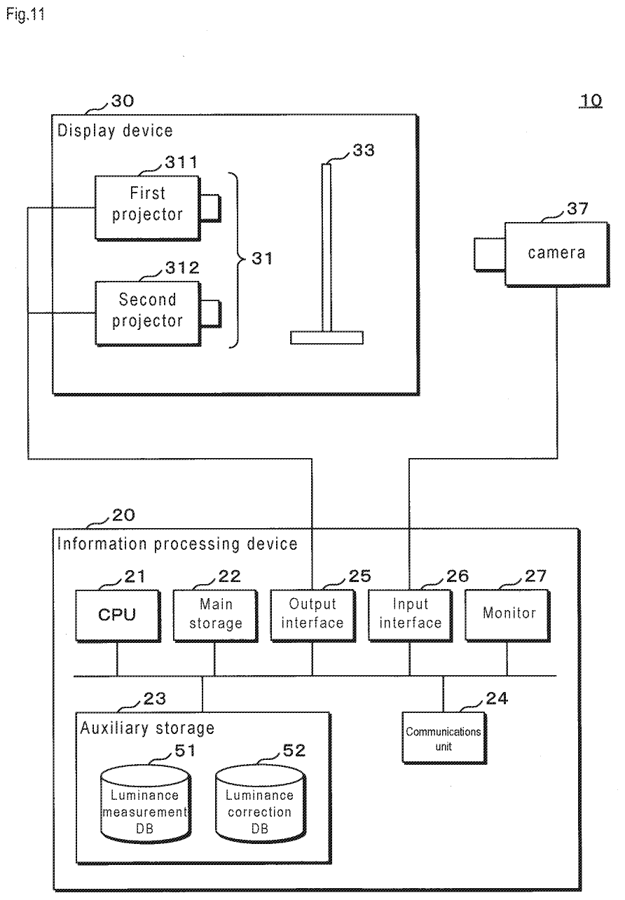

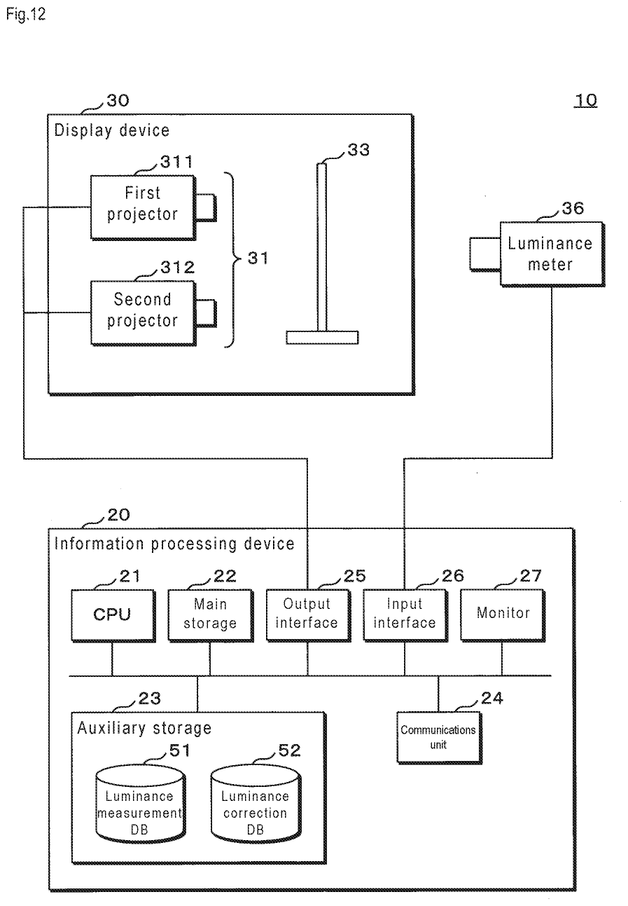

FIG. 12 is an illustration of the configuration of the information processing system 10 in the luminance distribution acquisition step of this configuration 3. In the step of acquisition of the luminance distribution, camera 37 is replaced by a luminance meter 36.

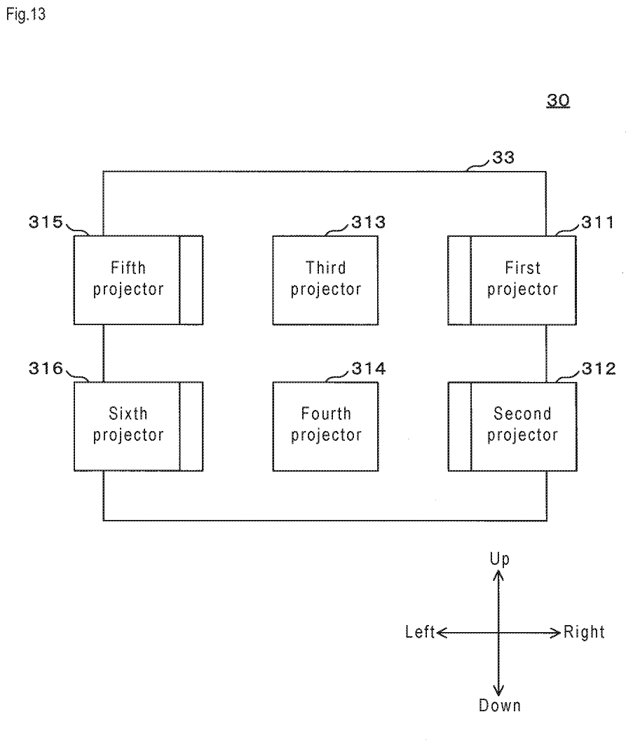

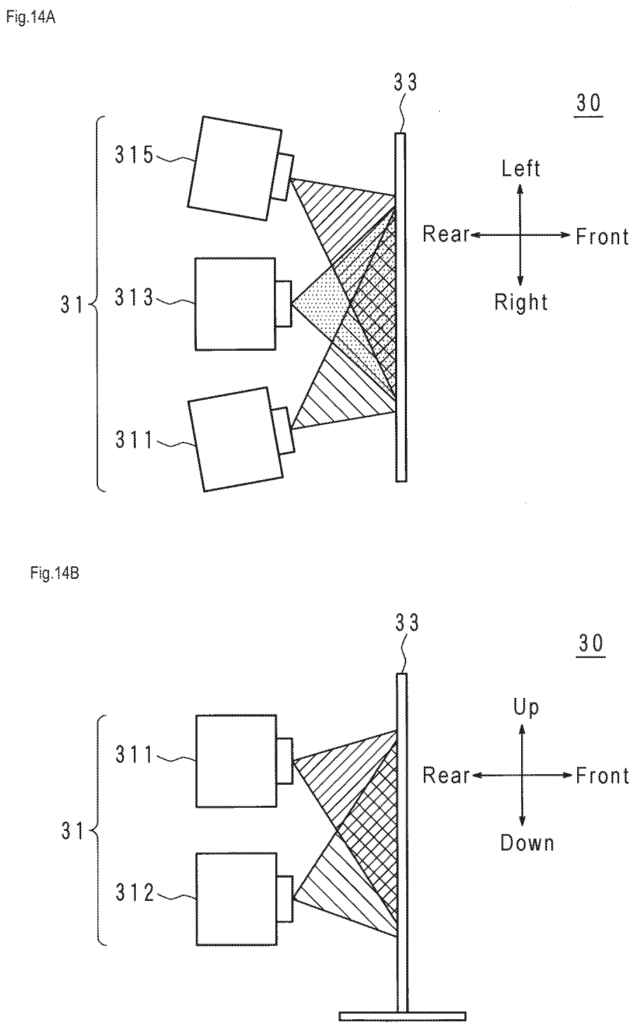

FIGS. 13 and 14 show the layout of projector 31 and screen 33. FIG. 13 is a view of projector 31 and screen 33 from the rear of projector 31. FIG. 14A is a view of projectors 31 and screen 33 from above. FIG. 14B is a view of projectors 31 and screen 33 from the right side. FIG. 14 shows schematically the projection status of each projector 31 to screen 33.

In the present configuration, a total of six projectors 31 are used, in two rows of three projectors from left to right, i.e. in three columns of two projectors from top to bottom. The projectors 31 at both ends in the horizontal direction are arranged in the form of a truncated fan so that the axis of each of these projectors 31 at both ends in the horizontal direction is oriented towards the optical axis of projector 31 in the middle position.

A group of several projectors 31 can be housed in a single enclosure and thus be supplied in an integrated form that appears to be a single projector. When projectors are thus supplied as a single integrated projector, all or part of projector group 31 can share optical components, such as projection lenses, relay optics or spatial light modulators, for example. All or part of projector group 31 can also share a single optical path. All or part of Projector 31 can share power supply circuits, command and control circuits, and so on.

As shown in FIG. 14, projectors 31 are adjusted to project an image onto screen 33 in an area approximately the same as screen 33 using a lens shift function, with focusing also being performed. The arrangement of projectors 31 shown in FIGS. 13 and 14 is only an example, as any number of projectors 31 can be placed in any position.

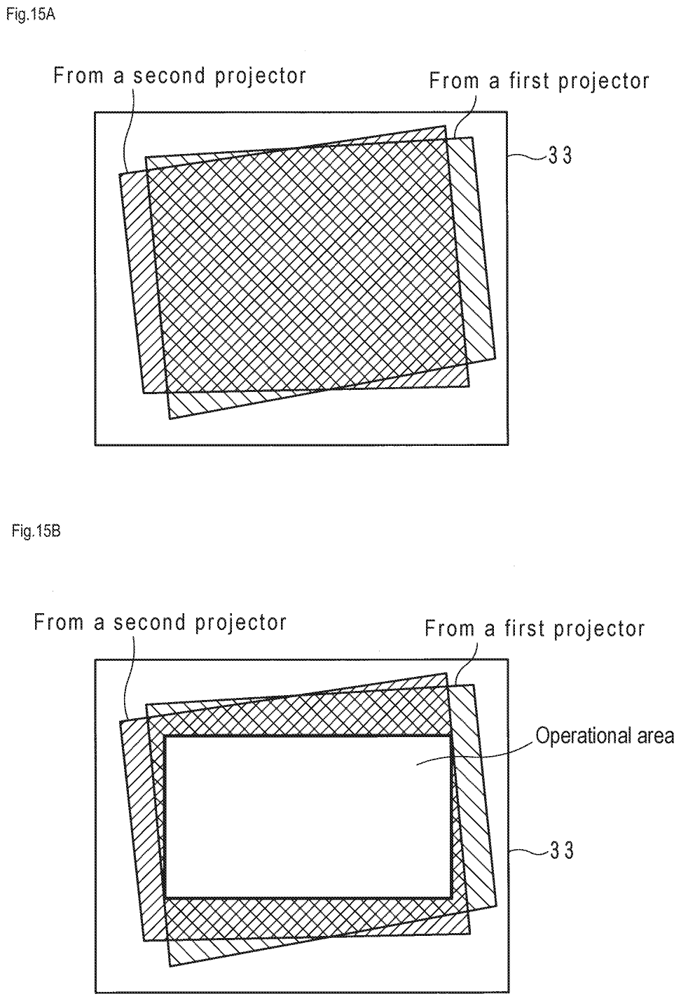

FIG. 15 is an illustration of the projection state from projectors 31. In FIGS. 15, only two projectors 31, a first projector 311 and a second projector 312, are used for explanation.

Even if the projection area of each of the projectors 31 is adjusted to correspond as much as possible to a common projection area by adjusting the installation position and lens shift of these projectors 31, the projection area of these projectors will differ, as shown in FIG. 15A.

CPU 21 operates projectors 31 one by one and acquires the projection area of each of these projectors 31 via camera 37. The central processing unit 21 superimposes the projection area of each projector 31 on screen 27, as shown in FIG. 15A, and displays it on screen 27. The user can enter the operational range or area of use, for example by dragging a mouse over it.

The CPU 21 can automatically determine the operational range by calculating a rectangle with a predetermined aspect ratio that is included in the projection area of each of the projectors 31. In the following description, the coordinates in the operational range will be used to indicate the position on the screen 33.

The operational range can be defined as the projection range common to any number of projectors 31, for example, three or more projectors.

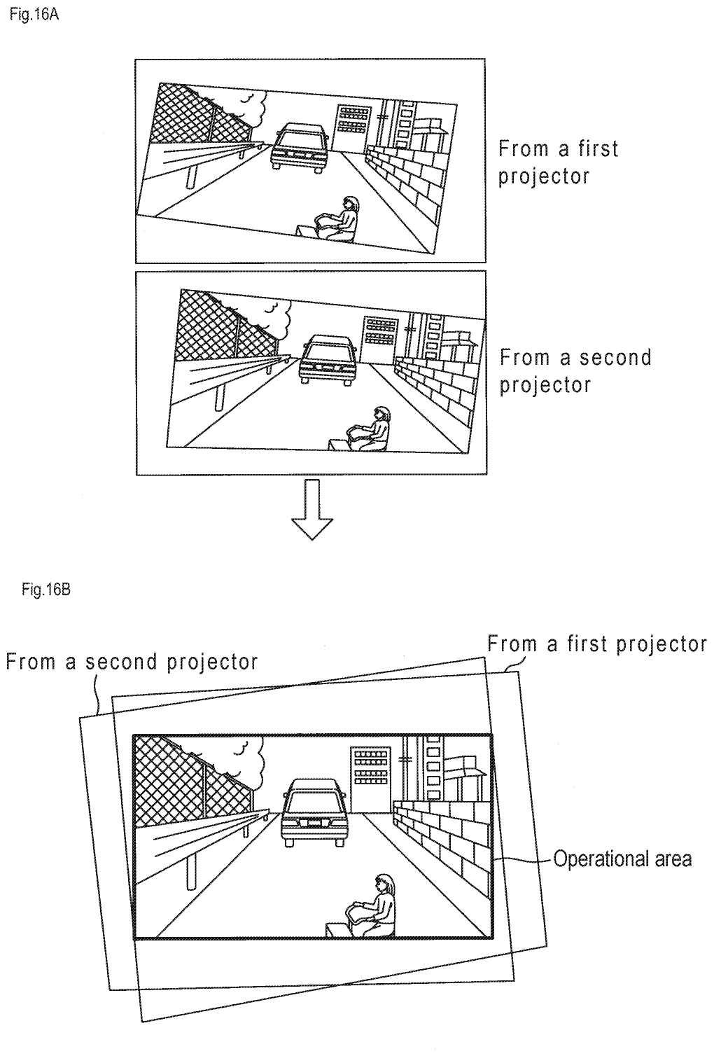

FIG. 16 shows the projection state of the projectors 31. In FIG. 16, two projectors 31, a first projector 311 and a second projector 312 are used for explanation.

The CPU 21 transmits image data to each of the projectors 31, which are transformed from the original image to project a predetermined image over the operational range. Projectors 31 project the input images onto screen 33, as shown in FIG. 16A. Each image is superimposed on screen 33, resulting in a high intensity image within the operational range of screen 33.

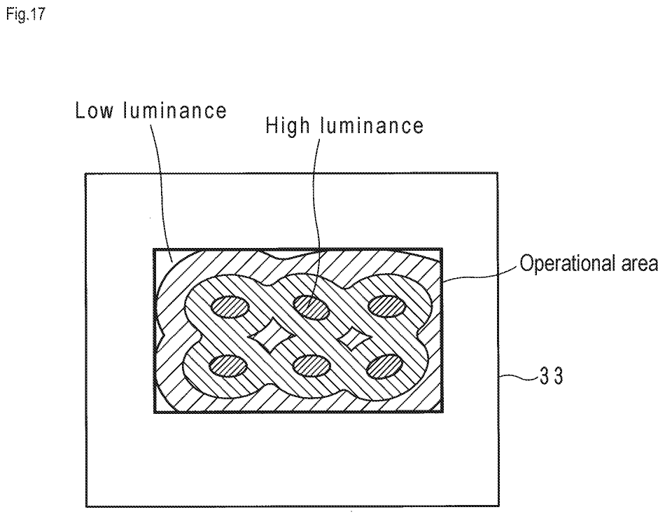

FIG. 17 shows an example of the luminance measurement result of this configuration 3. FIG. 17 shows the results of measurements made with a luminance meter 36 when a uniform gray image is projected simultaneously by all projectors 31 to an operational range. The 36 luminance meter is arranged to measure the luminance of this operational range. As shown in FIG. 17, high luminance ranges correspond in number to the number of projectors 31.

As in the case of configuration 1, by entering the image data with corrected luminance distribution into each of the projectors 31, a real luminance image can be displayed on screen 33. Furthermore, such a high luminance image cannot be reproduced by only one projector 31 on screen 33.

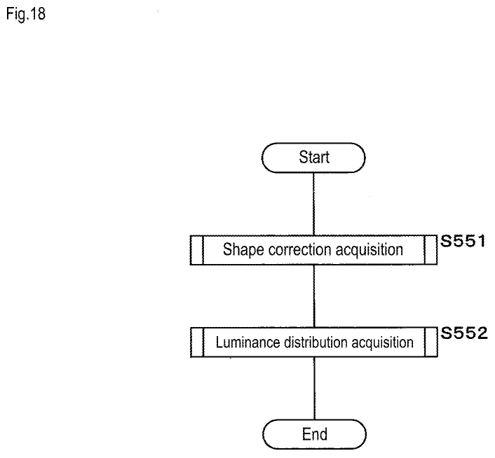

FIG. 18 is a flowchart illustrating the program processing sequence in the preparatory phase of configuration 3. The CPU 21 starts a deformation acquisition subroutine (step S551). The deformation acquisition subroutine is a subroutine that acquires an operational scope based on the projection range of the different projectors 31 and stores the shape correction information that transforms the image to be input into the projectors 31 as described using FIG. 15, and as described using FIG. 16A. The processing flow of the shape acquisition subroutine is described below.

CPU 21 starts a subroutine to obtain the luminance distribution (step S552). The luminance distribution acquisition subroutine is a subroutine that measures the luminance distribution and creates a luminance correction database 52 as described in FIG. 17. The processing flow of the luminance distribution acquisition subroutine is described below; the CPU 21 then terminates the processing.

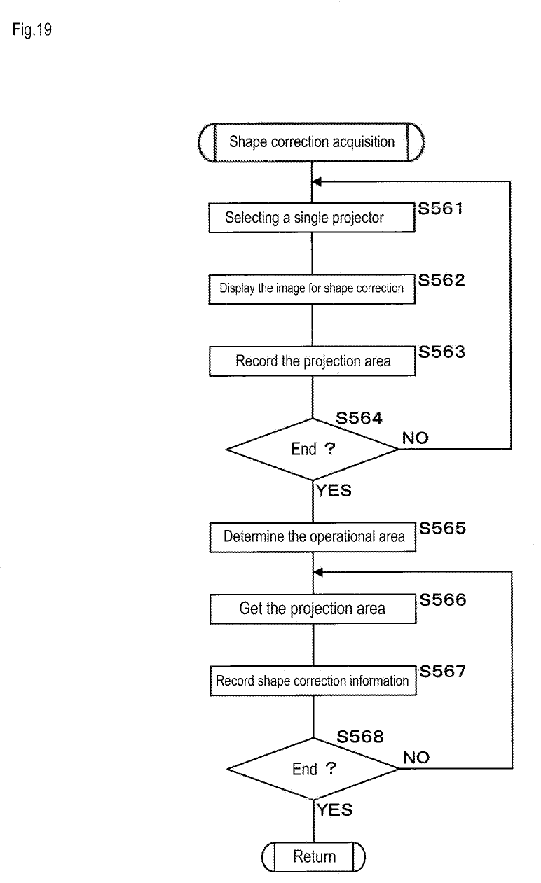

FIG. 19 is a flowchart illustrating the processing flow of the deformation acquisition subroutine: CPU 21 selects a projector 31 (step S561). The central processing unit 21 displays an image for deformation acquisition using the display unit 30 (step S562). For example, the central processing unit 21 projects an image for deformation acquisition that has a maximum brightness value over the entire projected surface from projector 31 via output interface 25. This causes a white image to be displayed on the screen 33.

The image used to acquire the deformation can be any image, such as a so-called checkerboard image in which white and black squares are arranged alternately. In the following explanation, this will be the example of the case where an all-white image is used as an image for deformation acquisition.

The CPU 21 acquires the projection area of the white image via camera 37 and stores it in the auxiliary storage device 23 (step S563). CPU 21 then determines whether processing for all projectors 31 is complete or not (step S564). If it is determined that processing is not complete, CPU 21 returns to step S561.

If it is determined that processing is complete, the CPU 21 determines the operational scope described in FIG. 15B (step S565). CPU 21 can determine the operational scope by taking into account, for example, data entered by the user; but CPU 21 can also determine the operational scope by automatically calculating a rectangle of a predetermined aspect ratio that is included in the projection area for each of the projectors 31.

The CPU 21 obtains the projection range recorded in step S563 for a projector 31. CPU 21 corrects the projected image on screen 33 by distorting the original image as described in FIG. 16A, based on the acquired projection area, the operational range determined in step S565 and the shape correction information. The shape correction information is calculated and stored in auxiliary storage device 23 (step S567). The shape correction information can be represented, for example, by a matrix that distorts the image by a coordinate transformation. The method used to distort the image is a conventional method and is therefore not described.

CPU 21 determines whether processing of all projectors 31 is complete or not (step S568). If it is considered not completed (NO in step S568), CPU 21 returns to step S566. If it is considered complete (YES in step S568), CPU 21 terminates processing.

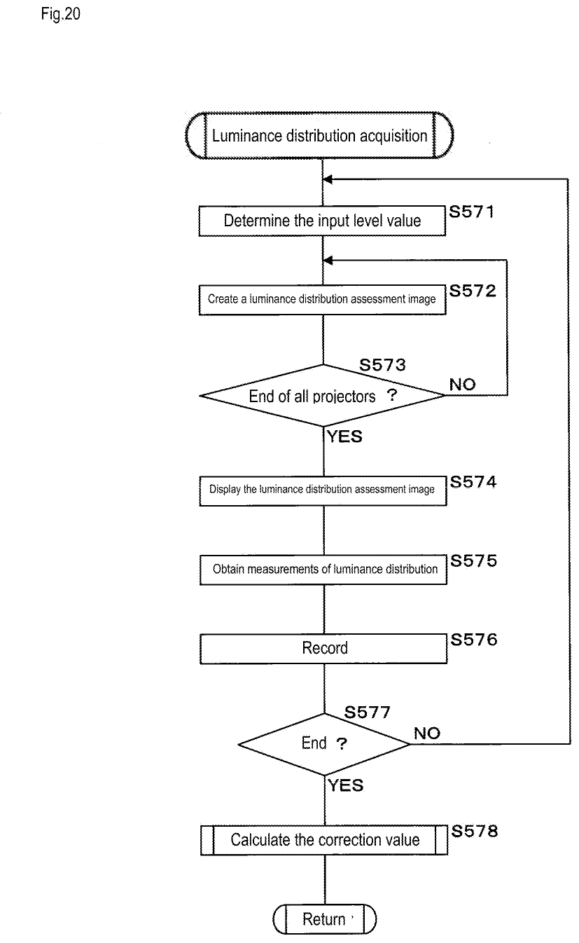

FIG. 20 is a flowchart illustrating the flow of the luminance distribution acquisition routine. The luminance distribution acquisition subroutine is a subroutine that measures the luminance distribution described in FIG. 17 and creates a luminance correction database 52.

CPU 21 determines a value for the input level (step S571). An arbitrary value can be determined for the interval value of the input level, e.g. every ten elementary levels. CPU 21 creates an evaluation image of the luminance distribution based on the shape correction information stored in the auxiliary storage device 23 (step S572). Specifically, CPU 21 creates the image data to project the image of the input level value determined in step S571 onto the operational range described using FIG. 15B, and stores the image data in auxiliary storage device 23.

CPU 21 determines whether processing for all projectors 31 is complete or not (step S573). If it is determined that it is not completed (NO in step S573), CPU 21 returns to step S572.

If the processing is judged to be complete (YES in step S573), the CPU 21 displays the evaluation image of the luminance distribution (step S574). Specifically, CPU 21 transmits the data of the luminance distribution evaluation image created in step S572 to projectors 31 via output interface 25. Projectors 31 project the image onto screen 33 based on the image input data. The image projected by each projector 31 is superimposed on the operating range described using FIG. 15. With the above, the evaluation image of the luminance distribution is displayed on screen 33.

CPU 21 acquires the measured values of the luminance distribution from the luminance meter 36 via interface 26 (step S575). CPU 21 stores the measured values in the fields corresponding to the input level values determined in step S571 for each coordinate position in the database of the actual luminance measurements 51 (step S576)

The relationship between input level value and luminance on screen 33 is the same for any position on screen 33. Therefore, by displaying a single evaluation image of the luminance distribution on screen 33 and measuring the luminance, the relationship between the input level value of each projector 31 and the luminance on screen 33 can be obtained to create a database of actual luminance measurements 51. By using the data of the input level values of each projector 31 and the luminance data on screen 33, the actual luminance display can be performed with high accuracy.

CPU 21 determines whether or not the measurement of the predetermined input level value has been performed (step S577). If it is judged that the measurement is not complete (NO in step S577), the processor returns to step S571. If it is judged that the measurement is complete (YES in step S577), CPU 21 starts the subroutine for calculating the correction value (step S578). The subroutine for calculating the correction value is the same as described in FIG. 8. The CPU then terminates the process.

FIG. 21 is a flowchart illustrating the processing flow of a program at the stage of using configuration 3. CPU 21 obtains the original image data from Auxiliary Storage Device 23 or another server or similar equipment connected via a network (step S581). The original image data is real luminance image data and therefore includes information about the real luminance.

CPU 21 acquires the luminance value of a pixel in the image acquired in step S581 (step S582). For the pixel from which the luminance is acquired, CPU 21 calculates the position in the operational range described in FIG. 15B (step S583). CPU 21 obtains the value of the input level corresponding to the luminance calculated in step S582 by referring to the luminance correction database 52 (step S584). To do this, CPU 21 performs an interpolation based on the luminance correction database 52 and calculates the input level values corresponding to the position in question and displays the luminance values calculated in step S583.

CPU 21 stores the input level values obtained in step S584 in relation to the positions calculated in step S583 (step S585). CPU 21 determines whether processing for all pixels of the original image data has been completed or not (step S586). If it is determined that processing is not complete (NO in step S586), the CPU returns to step S582.

If the treatment is considered complete (YES in step S586), CPU 21 obtains the shape correction information corresponding to a projector 31 from auxiliary storage device 23 (step S591). In this step S591, CPU 21 performs the function assigned to the third acquisition unit in this configuration.

CPU 21 transforms the image data formed by the input level values for each pixel recorded in step S585 according to the shape correction information (step S592). In this step S592, CPU 21 performs the function assigned to the shape correction unit of the current configuration.

CPU 21 transmits the image data from step S592 to projectors 31 via output interface 25 (step S593). Projectors 31 project an image on screen 33 based on the image input data.

CPU 21 determines whether processing for all projectors 31 is complete or not (step S594). If it determines that it is not completed (NO in step S594), the Central Processing Unit returns to step S591. If it determines that processing is complete (YES in step S594), the Central Processing Unit 21 will terminate processing.

In the present configuration, to the extent that the image is projected by several projectors 31 for an entire operational range, the information processing device 20 can provide a display in real luminance while a single projector would be limited to only a portion in high luminance.

In the subroutine for obtaining the luminance distribution described in FIG. 20, a luminance correction database 52 can be created for the use of one or more projectors 31. For example, for a relatively dark image, a small number of projectors 31 can be used to obtain a relatively dark image, and all projectors 31 can be used for an image with a high luminance portion.

By using the minimum required number of projectors 31, it is possible to realize an information processing unit 20 that displays low luminance images but in real and precise luminance. This saves power consumption and extends the service life of projectors 31.

For displaying the same image, all projectors 31 can be used for areas that include a high luminance portion, while one or more projectors 31 can be used for other parts of the image. Since no overlay projection is performed on the low-luminance parts, Information Processing System 10 can be provided to display a high-resolution image.

Configuration 4

The present configuration concerns an information processing system 10 that uses auxiliary projectors 32 that project an image over only part of the operational range. The description of the common parts of configuration 3 is omitted.

FIG. 22 illustrates the layout of projectors 31 and screen 33 in this configuration 4. FIG. 22A is a view of projectors 31, auxiliary projectors 32 and screen 33 from the top of projectors 31, auxiliary projectors 32 and screen 33. FIG. 22B is a view of projectors 31, auxiliary projectors 32 and screen 33 from the rear of projectors 31.

In this configuration, two auxiliary spotlights 2 are arranged in a truncated fan shape on either side of the six spotlights 31 themselves arranged in the same way as in configuration 3.

FIG. 23 is an illustration of the projection status of projectors 31 in the case of this configuration 4. FIGS. 22 and 23 will be used to explain the projection range of projectors 31 in this configuration.

The six projectors 31, from the first projector 311 to the sixth projector 316, are capable of projecting an image onto an area that includes the operational range.

The first and second auxiliary projectors 321 and 322, located on the right side, project the image onto the right half of the truncated operational range. As shown by the dashed lines in FIG. 22A and FIG. 23, the right half of the projected area of the first and second auxiliary projectors 321 and 322 is not used.

Similarly, the third and fourth auxiliary projectors 323 and 324, located on the left side, project images on the left half of the truncated operational range. As shown by the dotted lines in FIGS. 22A and 23, the left half of the projection area of the third and fourth auxiliary projectors 323 and 324 is not used.

In the present configuration, Information Processing System 10 can become a processing system capable of displaying high luminance as real luminance even near the edges of the operational range.

In the present configuration, Information Processing System 10 can become a processing system capable of displaying a high luminance image in real luminance over a very large area.

The number of auxiliary projectors 32 may be less than three or more than five. Auxiliary 32 projectors can be placed at any location. The size of the projection area of auxiliary projectors 32 can be different from the size of the projection area of projectors 31.

Configuration 5

The present configuration concerns an information processing system 10 with several screens 33. The description of the common parts of configuration 3 is omitted.

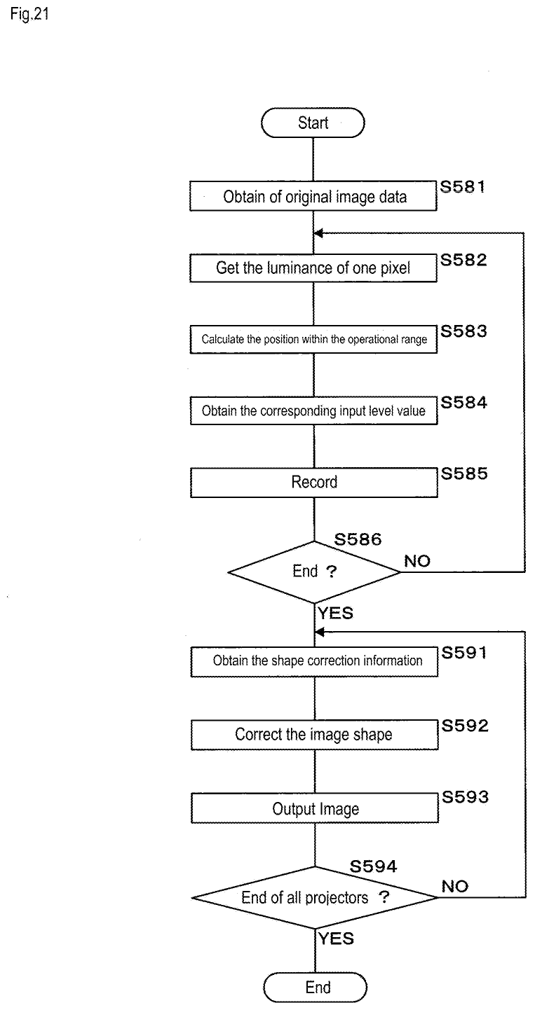

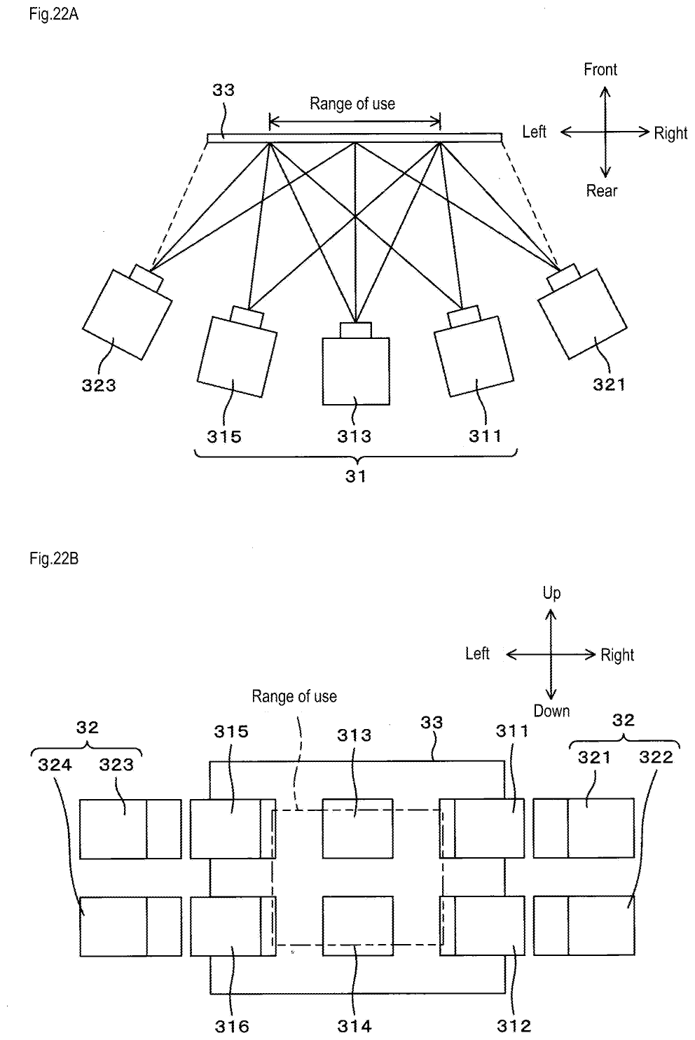

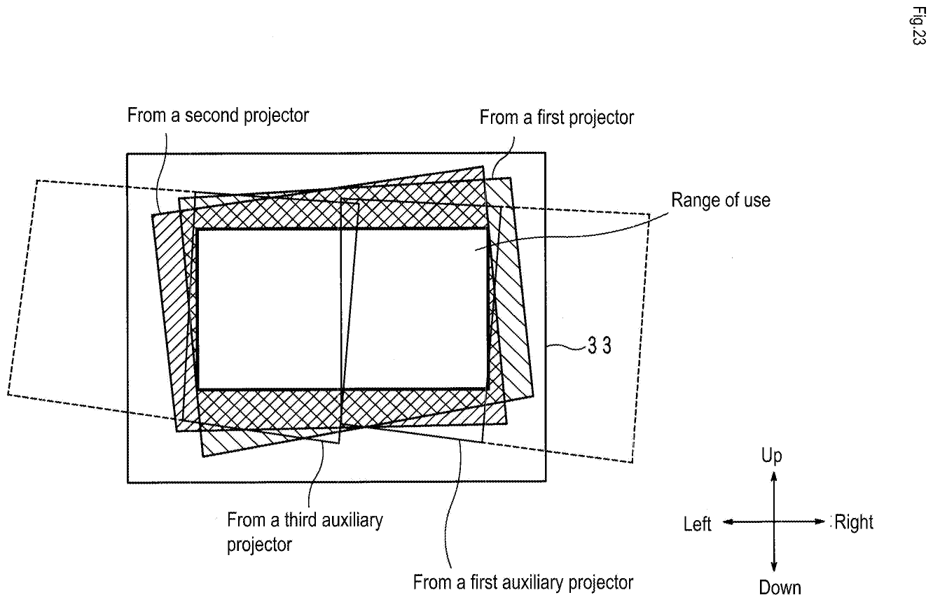

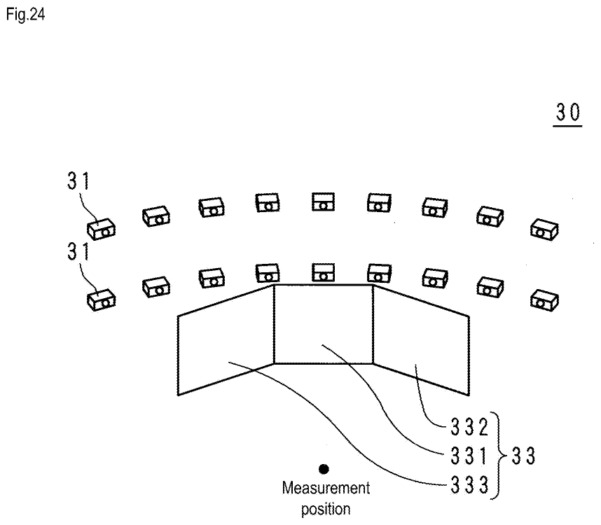

FIG. 24 illustrates the arrangement of projectors 31 and screen 33 in the case of configuration 5. The display 30 in this configuration includes a first screen 331. A second screen 332 is arranged consecutively on one side of the first screen 331, and a third screen 333 is arranged consecutively on an opposite side of the first screen 331. In the following description, screens 331 to 333 will be referred to as screens 33 when it is not necessary to distinguish between them.

Behind each screen 33 there are six projectors 31, each of these groups being located behind each screen 33. The optical axis of each projector 31 is arranged in such a way that this optical axis is oriented towards the measuring position.

Thus, a horizontal image called panoramic image with real brightness is projected from a total of eighteen projectors 31, successively on the three screens 33.

In the present configuration, it is possible to provide an information processing system 10 capable of evaluating a camera 15 to be tested from a wide angle. As the rear axis of each projector 31 is oriented towards the measurement position, the information processing system 10 can become a processing system capable of displaying a high brightness image in real brightness.

Screen 33 can be composed of four or more screens. Screen 33 can also be connected vertically.

Screen 33 can be curved. This can allow to build an information processing system that is less affected by the angle breaks of screen 33.

Configuration 6

The present configuration concerns an information processing system 10 in which a human user visually observes an image in real luminance. The description of the common parts of configuration 3 is omitted.

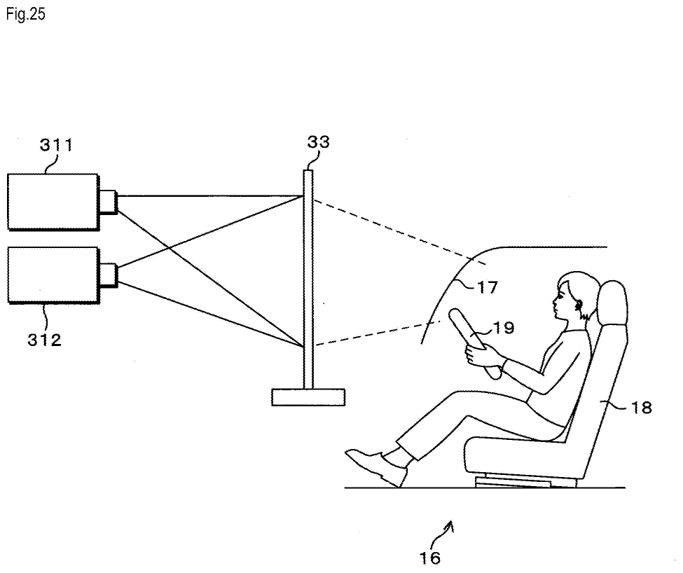

FIG. 25 is an example illustration of the configuration of the information processing system 10 in the case of the present configuration 6. Seat 18 of the vehicle is positioned so that the user's eyes are near the measurement position when seated. The windshield 17, steering wheel 19, dashboard, etc., are positioned in relation to the position of seat 18.

A real luminance image is displayed on screen 33. The user can, for example, evaluate the visibility of the dashboard when hit by the headlights of an oncoming vehicle, by the morning low sun or by the setting sun, etc. The user can also evaluate the visibility of the dashboard when hit by the headlights of an oncoming vehicle, by the morning low sun or by the setting sun. The user can also evaluate the visibility of a “HUD” head-up display system, which projects various informations onto the windshield 17.

In this configuration, an information processing system 10 can perform a real luminance display to serve as a visual for a driving simulator that allows, for example, to experience phenomena such as glare caused by the headlights of an oncoming vehicle.

Configuration 7

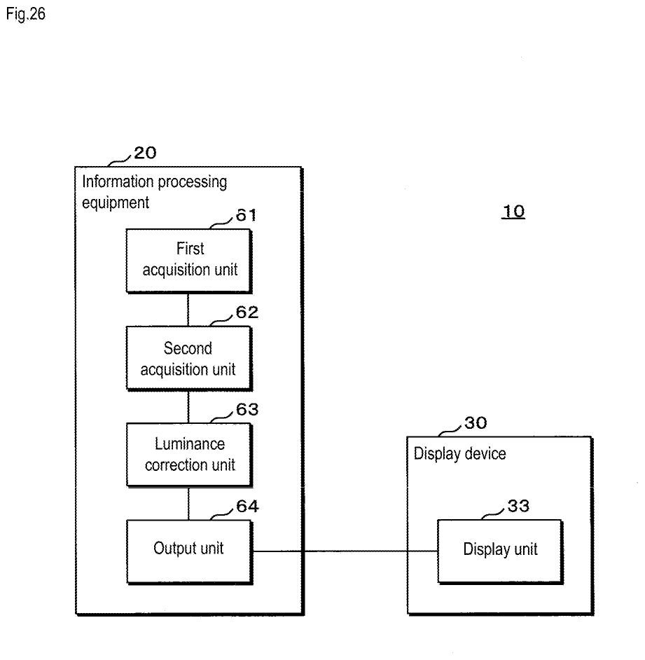

FIG. 26 is a block diagram illustrating the operation of the data processing device 20 in the case of configuration 7. The information processing device 20 operates on the basis of control by a central processing unit 21, as follows.

The information processing system 10 includes a display device 30 and an information processing device 20. The display device 30 has a display unit 33 that displays an image. The information processing device 20 has a first acquisition unit 61, a second acquisition unit 62, a brightness correction unit 63, and an output transmission unit 64.

The first acquisition unit 61 acquires luminance correction information that corrects the measured luminance from a predetermined measurement position on the image display unit according to the input signal to match the luminance information contained in the input signal. The second acquisition unit 62 acquires an image to be displayed on the display unit 33. The brightness correction unit 63 corrects the image acquired by the second acquisition unit 62 based on the correction information acquired by the first acquisition unit 61. The output transmission unit 64 transmits the image corrected by the brightness correction unit to the display unit.

Configuration 8

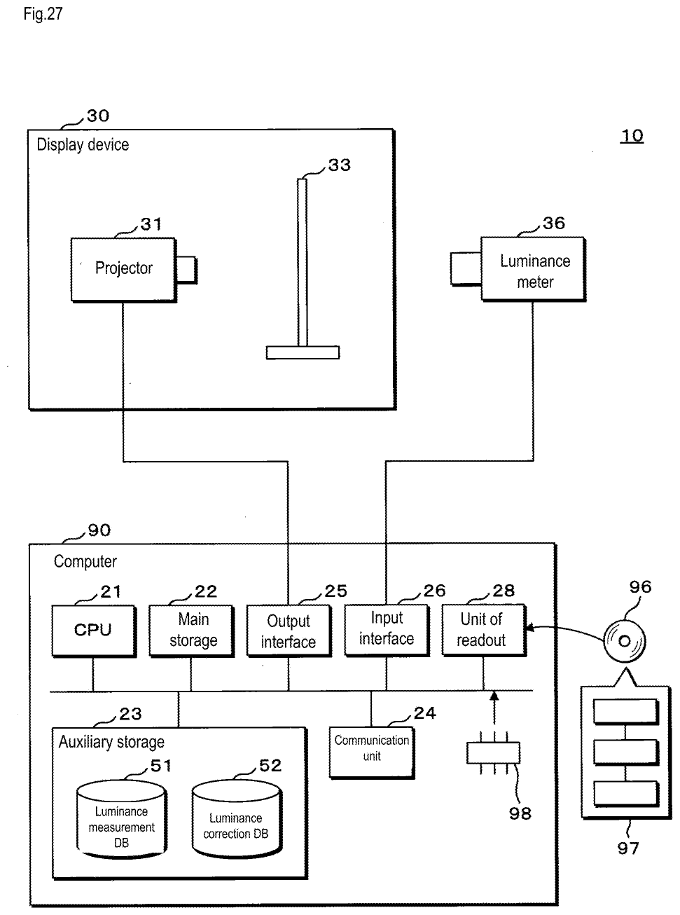

The present configuration refers to a form of realization of the information processing system 10 which associates a general-purpose computer 90 with a program 97 for its operation. FIG. 27 is an illustration of the configuration of such an information processing system 10 corresponding to this configuration 8. The description of the common parts with configuration 1 is omitted.

The information processing system 10 of the present version includes a computer 90, a display 30 and a luminance meter 36.

Computer 90 consists of a central unit 21, a main storage device 22, an auxiliary storage device 23, a communication unit 24, an output interface 25, an input interface 26, a readout unit 28 and a bus. Computer 90 can be a general-purpose personal computer, a tablet or other information device.

Program 97 is recorded on a portable storage medium 96. The CPU 21 reads program 97 from the playback unit 28 and stores program 97 in an auxiliary storage device 23. The CPU 21 can also read program 97 stored in solid-state memory 98, or a flash memory mounted in the computer 90. In addition, the CPU 21 can download program 97 from the communication unit 24 or another server or similar equipment not specified, which is connected via the communication unit 24 to a network not specified, and store program 97 in the auxiliary storage device 23.

Program 97 is installed as the control program of computer 90 and is loaded into the main storage device 22 to be executed. This allows computer 90 to function as the information processing device 20 described above.

Configuration 9

The present configuration is a form in which the coordinates of an image to be projected from projectors 31, the coordinates in the operational range described using FIG. 15, and the data of the original image are converted sequentially using a conversion database. Parts common to configuration 3 will be omitted in the description.

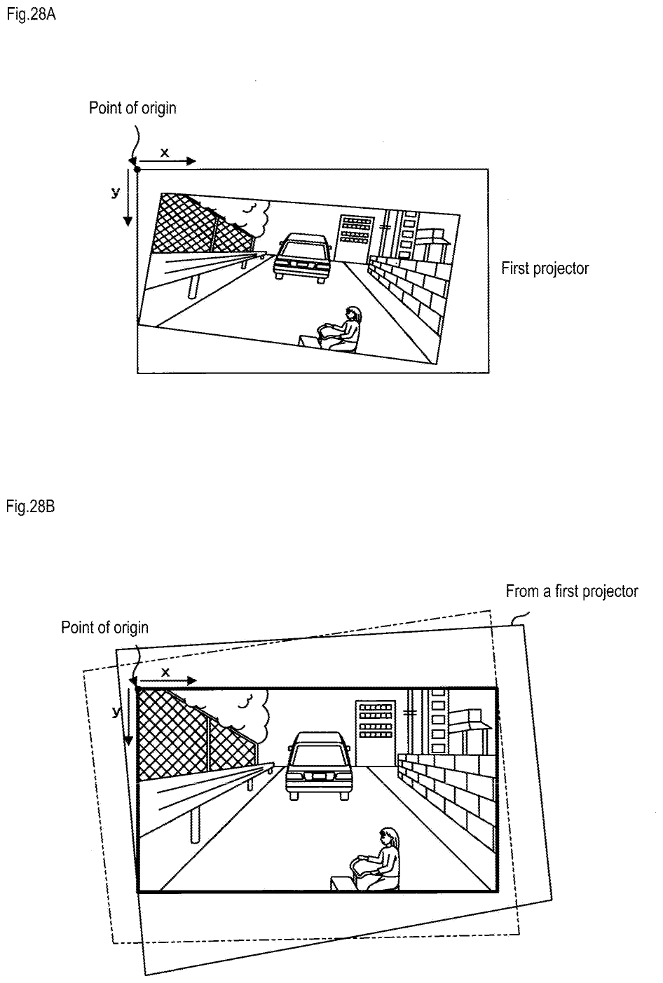

FIG. 28 illustrates the conversion between the coordinates of an image to be projected from projectors 31 and the coordinates of an operational range. FIG. 28A shows the coordinates of the image entered into the first projector 311, i.e. the coordinates of this projector. The upper left corner of the image is defined as the origin (0, 0), with the x-axis facing right and the y-axis facing down. For example, using the first 311 projector with square-shaped pixels at a resolution of 1080p, x is an integer from 0 to 1919 and y is an integer from 0 to 1079.

FIG. 28B shows the coordinates of the operational scope. With the upper left corner of the operational range as the origin (0, 0), the x-axis is defined in the right direction and the y-axis in the bottom direction. For example, if the luminance distribution of the operational range described in FIG. 17 is measured at a resolution of 2048 pixels by 1080 pixels, x is an integer from 0 to 2047 and y is an integer from 0 to 1079.

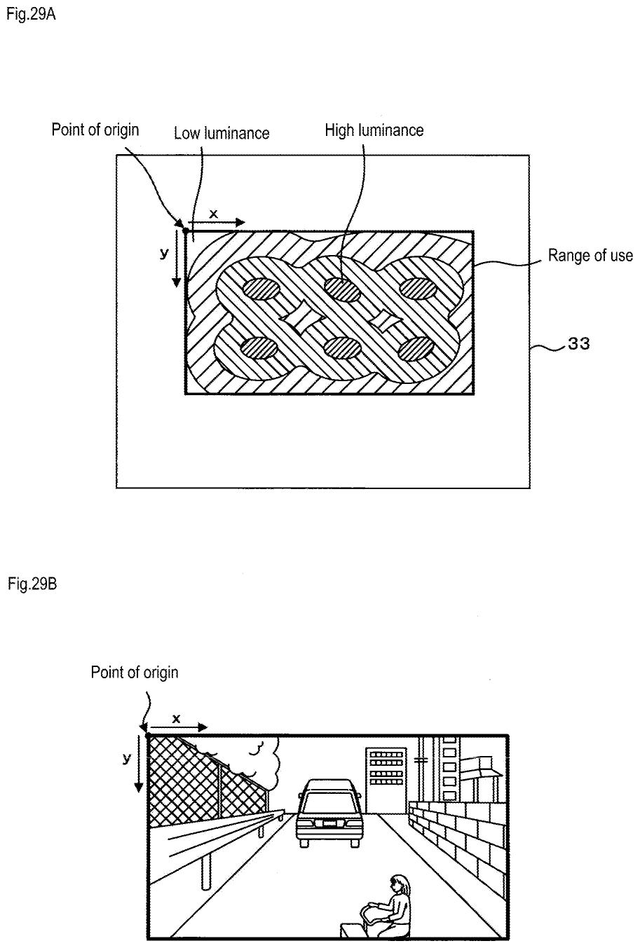

FIG. 29 illustrates the conversion between the coordinates of the operational range and the coordinates of the original image data. FIG. 29A shows the operational range coordinates. As in FIG. 28B, the x-axis is defined to the right and the y-axis is defined downward, with the upper left corner of the operational range as the origin (0, 0).

FIG. 29B shows the coordinates of the original image data. The upper left corner of the original image data is defined as the origin (0, 0), with the x-axis pointing to the right and the y-axis pointing down. For example, if the original image data is a square pixel at a resolution of 1080p, x is an integer from 0 to 1919 and y is an integer from 0 to 1079.

All numbers of pixels described using figures. 28 and 29 are given as examples. The image to be projected from projectors 31, the operational range and the data of the original image may differ from each other with regard to the ratio between their height and width.

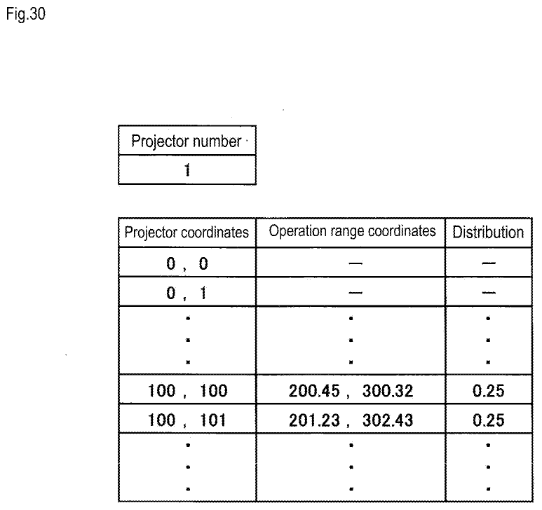

FIG. 30 illustrates the record structure of the first conversion database. The first conversion database is a database that records the projector coordinates of an image to be projected from projectors 31, the coordinates of the operational range and the luminance distribution between each projector 31 in combination with the projector coordinates, the coordinates of the operational range and the luminance assignment to each projector 31. The first conversion database consists of a projector number field, a projector coordinate field, an operational range coordinate field and a luminance distribution field.

The projector number field records the number given to each projector 31 in sequential order. The projector coordinate field records each coordinate of the image to be projected from each of the projectors 31 as described in FIG. 28A. The operational range coordinate field records the coordinates of the operational range described in FIG. 28B.

As shown in FIG. 28, the area near the origin of the projector coordinates is not included in the operating range. For these coordinates, a “-” symbol is stored in the coordinate field of the operational range. In FIG. 30, the point where the projector coordinates are “100, 100” in the first 311 projector indicates that the point where the projector coordinates are “100, 100” is projected to a point in the operational range whose coordinates are “200.45, 300.32”.

In the distribution area, the luminance distribution between the projectors 31 is recorded. In FIG. 28, for the position of the projector coordinates “100, 100” for the first projector 311, the number “0.25” recorded in the distribution field means that 25 percent of the total luminance is assigned to the first projector 311. If the projector is out of range and does not project light, a symbol “-” is recorded in the distribution field.

The value of the distribution field is determined so that the sum is 1 for each position in the operational range. If there is a mixture of high and low luminance 31 projectors, the characteristics of each 31 projector can be used effectively by increasing the value of the distribution field of the high luminance 31 projectors.

The value of the distribution field can be defined so that the value of the distribution field is proportional to the maximum luminance that each projector 31 can provide for each position in the operational range. This definition reduces the number of measurements of the luminance distribution and makes it possible to realize an information processing system 10 that can display the actual luminance with a small number of operations. In the following description of the present configuration, an example of a case where the luminance distribution is recorded in the allocation field will be used for explanation.

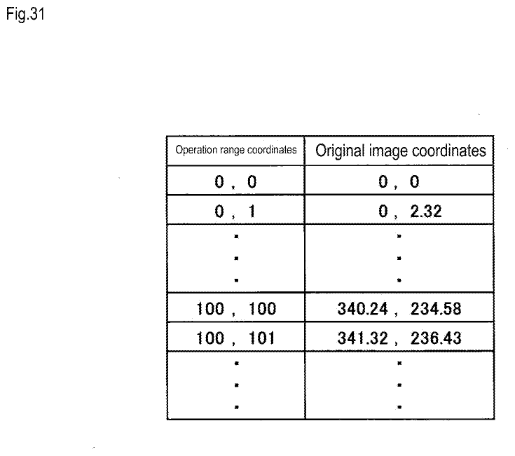

FIG. 31 illustrates the layout of the records in the second conversion database. The second conversion database is a database that records the operational range and coordinates of the original image. The second conversion database has an operational range coordinate field and a source image coordinate field.

The Operational Range Coordinate Field records the coordinates of the operational range as described in FIG. 29A. The source image coordinate field stores the coordinates as described using FIG. 29B. FIG. 31 shows that a point in the operational range whose coordinates are “100, 100” is projected to a point whose coordinates in the original image are “340.24, 234.58”.

For example, if the aspect ratio of the operational range is different from the aspect ratio of the source image, the source image is not projected to the edge of the operational range. In this case, a “-” symbol is stored in the original image coordinate field corresponding to the coordinates of the operational range that are not projected.

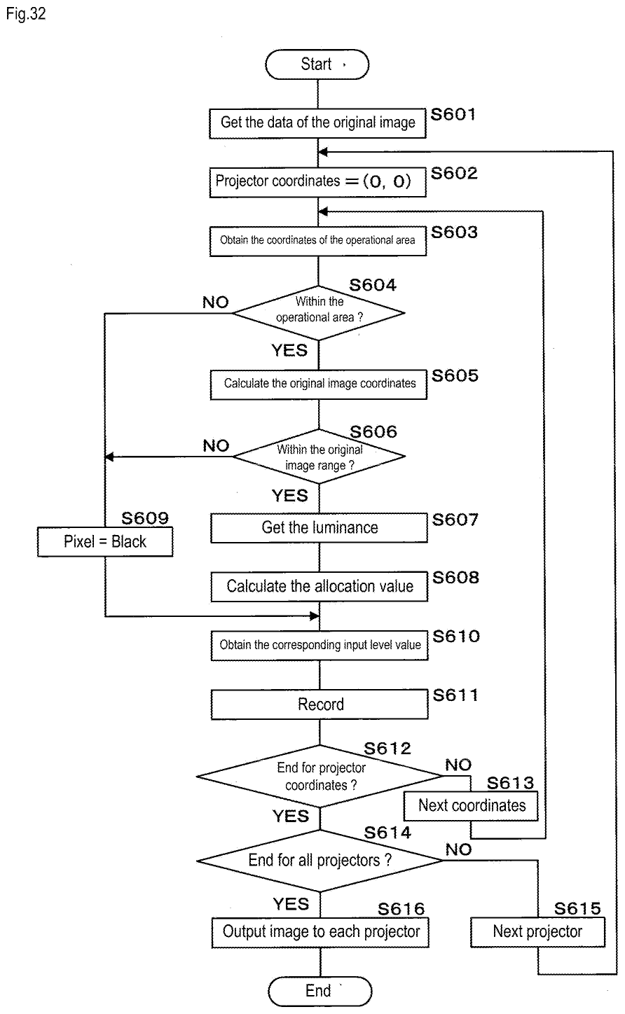

FIG. 32 is a flowchart illustrating the program flow of configuration 9. CPU 21 obtains the original image data from Auxiliary Storage Device 23 or another server or similar equipment connected via a network (step S601).

CPU 21 selects one of the projectors 31 for processing, a step omitted in the flowchart, and sets the initial value of the projector coordinates to “0, 0” (step S602). CPU 21 searches the first conversion database with the projector coordinates as key, and obtains the records extracted from the operational range coordinate field (step S603). CPU 21 determines whether or not the coordinates of the projector are within the operational range of coordinates (step S604). If they are outside the operational range coordinates (NO in step S604), the symbol “-” is recorded in the operational range coordinates obtained in step S603.

If the coordinates are determined to be within the operational range (YES in step S604), CPU 21 calculates the coordinates of the original image corresponding to the coordinates of the operational range (step S605). Specifically, CPU 21 searches the second database for conversion data using several coordinates close to the operational range coordinates obtained in step S603 as a key, extracts the records, and interpolates the original image coordinates from the extracted records to calculate the original image coordinates. The interpolation can be performed by any method, such as the nearest neighbor estimation method, bilinear method, bicubic method, etc.

CPU 21 determines whether the calculated coordinates of the source image are within the limits of the source image (step S606). For example, if the symbol “-” is recorded in the original coordinate field of the record extracted by the search in the second conversion database and the interpolation cannot be performed successfully, CPU 21 determines that the coordinates are outside the boundaries of the original image.

If the coordinates are judged to be within the range of the original image (YES in step S606), CPU 21 obtains the luminance of the pixel based on the original image data obtained in step S601 (step S607). For example, the luminance of the pixel can be the luminance of the point of the original image closest to the coordinates calculated in step S605. From the original image data, pixels close to the coordinates calculated in step S605 can be extracted and interpolated using any interpolation technique to calculate the luminance.

CPU 21 calculates the luminance allocated to projectors 31 by integrating the luminance calculated in step S607 according to the distribution recorded in the distribution field of the record extracted from the first conversion database in step S603 (step S608).

If the coordinates are determined to be outside the operational range (NOT in step S604) or outside the original image, CPU 21 determines that the pixel is black, i.e. the luminance of the pixel is zero.

After completion of step S608 or step S609, CPU 21 obtains the input level values corresponding to the pixel luminance (step S610). In this case, CPU 21 performs an interpolation based on the use of the luminance correction database 52 described in FIG. 6, and calculates the input level value corresponding to the position calculated in step S603 and the luminance value obtained in step S608 or step S609. In this configuration, a luminance correction database 52 is created for each projector 31 based on the projection luminance when said projector 31 is used alone.

CPU 21 records the input level values obtained in step S610 against the projector coordinates, and CPU 21 determines whether processing of all projector coordinates is complete or not (step S611). If the processing is considered not completed (NOT in step S612), CPU 21 selects the next coordinates of the projector to be processed, and CPU 21 returns to step S603.

If it is determined that the processing of all projector coordinates is complete (YES in step S612), the Central Processing Unit 21 determines whether or not the processing of all projectors 31 is complete (step S614). If it is judged that not all projectors 31 have been processed (NO in step S614), the Central Processing Unit 21 selects the next projector 31 to be processed, and the Central Processing Unit returns to step S602.

When it is determined that all projectors 31 have been processed (YES in step S614), the CPU 21 transmits the image to all projectors 31 (step S616). The image is projected from each of the projectors 31 to the screen 33. The result is a real luminance display, which projects an image on screen 33 with a luminance that is true to the original image data. The CPU terminates processing.

First Variant

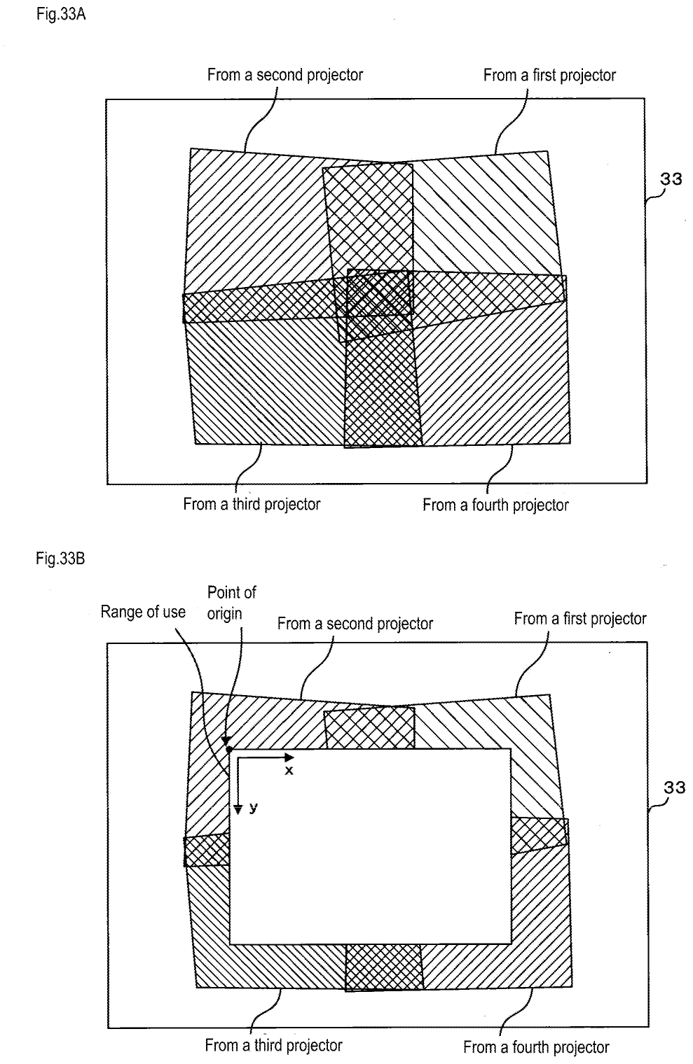

FIG. 33 is an illustration of a first variant of configuration 9. FIG. 33A shows the projection from the first projector 311 to the fourth projector 314 on screen 33. The edges of the projection ranges of the four projectors 31 overlap slightly with a simultaneous overlap of the four projectors 31 in the center.

FIG. 33B shows the operational scope superimposed on FIG. 33. For each projector 31, a first database of the conversion data described in FIG. 30 can be created. By preparing a distribution field in this first conversion database, the luminance can be appropriately assigned to each projector 31 even when the number of projectors 31 to be superimposed and projected varies depending on the location.

Second Variant

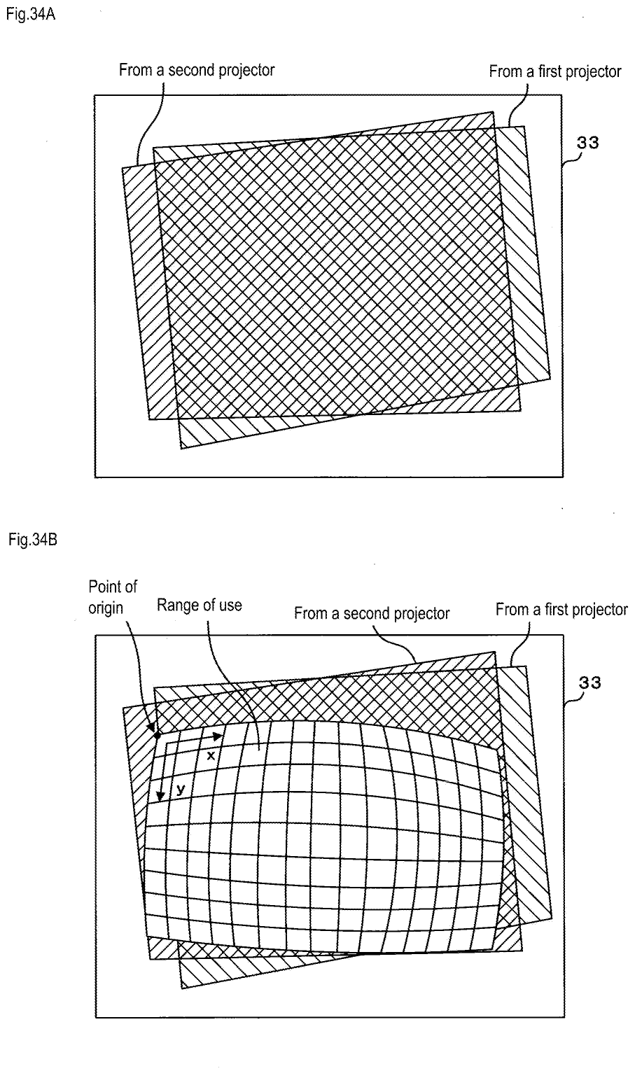

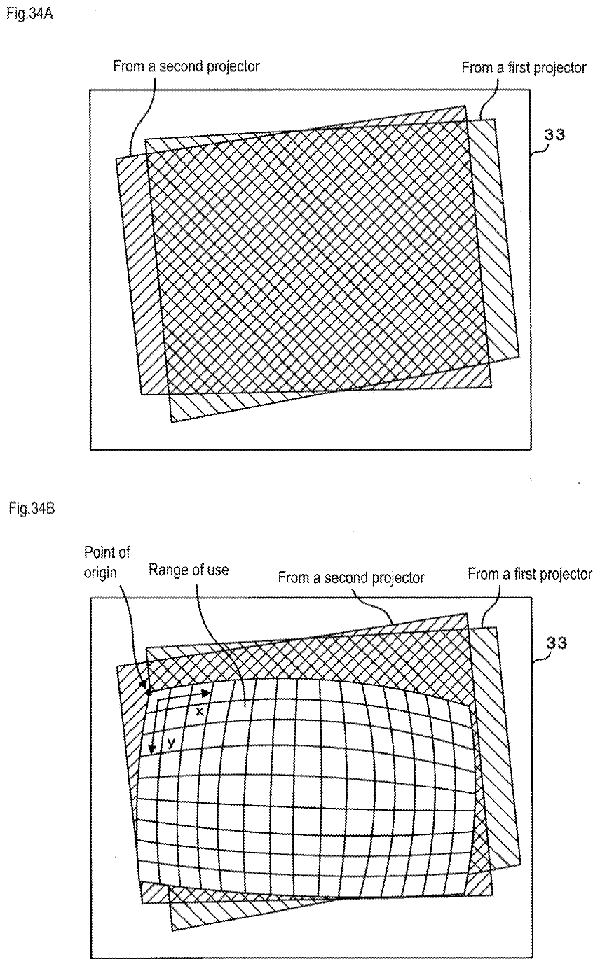

FIG. 34 is an illustration of a second variant of configuration 9. In this variant, a coordinate system transformed into a barrel-shaped coordinate system is used instead of an orthogonal coordinate system for the operational range. By creating the second transformation database described in FIG. 31 based on such a barrel-shaped coordinate system, the original image data can be transformed into a barrel-shaped display.

In this configuration, by combining the first and second bases of the conversion data, it is possible to obtain various types of projections, such as those described in FIGS. 33 and 34.

The technical characteristics (constituent requirements) described in each example can be combined with each other and, when combined, can form new technical characteristics.

The examples presented here are indicative in all respects and should not be considered restrictive. The scope of the invention is indicated by the claims, not by the descriptions above. It is intended to include all amendments in accordance with the claims.

### DESCRIPTION OF THE NUMBERING

10 Information processing system

15 Camera to be tested

16 Driving simulator

17 Windshield

18 Seat

19 Steering wheel

20 Information processing device

21 Central Processing Unit

22 Main storage device

23 Auxiliary storage device

24 Transmission unit

25 Output interface

26 Input interface

27 Control screen

28 Reading unit

30 Display device

31 Projectors

311 First projector

312 Second projector

313 Third projector

314 Fourth projector

315 Fifth projector

316 Sixth projector

321 First auxiliary projector

322 Second auxiliary projector

323 Third auxiliary projector

324 Fourth auxiliary projector

33 Screen (display unit)

331 First screen.

332 Second screen.

333 Third screen.

36 Luminance meter (two-dimensional color luminance meter)

37 Camera

51 Database of luminance measurements

52 Luminance correction database

61 First acquisition unit

62 Second acquisition unit

63 Luminance correction unit

64 Output transmission unit

96 Portable storage media

97 Computer program

98 Semiconductor memory

1. An information processing device, comprising:
a first acquisition unit which acquires luminance correction information for correcting the luminance of images displayed by a display unit. The said correction information associates to the input signal of an image the luminance measurements displayed from this input signal, measurements taken from a predetermined spatial position in front of the display unit,
a second acquisition unit, which acquires the image data to be displayed by the display unit,
a luminance correction unit, which corrects the image data acquired by the second acquisition unit on the basis of the luminance correction information acquired by the first acquisition unit, and
an output transmission unit that communicates the image data corrected by the luminance correction unit to the display unit.

2. The information processing device according to claim 1, further comprising:
a third acquisition unit for acquiring shape correction information to correct the shape of the image,
a shape correction unit, in which the image data corrected by the luminance correction unit is corrected on the basis of the shape correction information obtained by the third acquisition unit, and
an output transmission unit that outputs the image data corrected by the shape correction unit to the display unit.

3. The device for processing information according to claim 1, wherein
a correction of image data by a luminance correction unit as described above so that a display unit as described above can display a real luminance image corresponding to the image data, and
wherein said image data comprising data in trichromatic components is associated with the real luminance.

4. An information processing system comprising
a display device and
an information processing device,
wherein said display device integrates a display unit and allows image display, and
wherein said information processing device comprises:
a first acquisition unit that acquires luminance correction information in order to correct the luminance of the images displayed by the display unit, wherein said correction information associates to the input signal of an image the luminance measurements displayed from the input signal, measurements taken from a predetermined spatial position in front of the display unit,
a second acquisition unit, which acquires the image to be displayed by the display unit,
a luminance correction unit, which corrects the image acquired by the second acquisition unit based on the correction information acquired by the first acquisition unit, and
an output transmission unit that communicates the image corrected by the luminance correction unit to the display unit.

5. The information processing system according to claim 4, further comprising: a position acquisition unit for obtaining the measurement position as introduced above.

6. The information processing system according to claim 4,
wherein said display unit is a rear projection screen,
wherein said display device comprises several projectors capable of projecting an image onto said screen,
wherein the projectors are arranged in such a way that the projection areas overlap each other,
wherein the multiple projectors are equipped with a shape correction unit that allows the display by multiple overlaps on the screen of the image acquired from the second shape corrected acquisition unit,
wherein the luminance correction unit corrects in luminance the image already corrected in shape by the shape correction unit, and
wherein the output transmission unit communicates the image corrected by the luminance correction unit to each of the projectors.

7. The information processing system according to claim 6,
wherein a portion of the multiple projectors is arranged such that only a portion of their projection area overlaps the projection area of the other projectors.

8. An information processing method enabling a computer to perform the following processing operations:
Acquisition of luminance correction information in order to correct the luminance of the images displayed by the display unit. The said correction information associates to the input signal of an image the measurements of luminance displayed from the input signal, measurements taken from a predetermined spatial position in front of the display unit,
Acquisition of the image to be displayed by a display unit as described above,
Correction of the acquired image based on the luminance correction information, and
Transmission of the corrected image to the display unit.
